(19) United States
(12) Patent Application Publication
(10) Pub. No.: US 2002/0120507 A1
(43) Pub. Date: Aug. 29, 2002

(54) Feature rich advertisments including consumer requests for additional information

(76) Inventors: George Chanos, Henderson, NV (US); Lin Fisher, Brentwood, CA (US); Jason Cowles, Las Vegas, NV (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/043,876

(22) Filed: Jan. 10, 2002

Related U.S. Application Data
(63) Continuation-in-part of application No. 09/825,772, filed on Apr. 4, 2001.
(60) Provisional application No. 60/194,530, filed on Apr. 4, 2000.
(60) Provisional application No. 60/252,446, filed on Nov. 21, 2000.
(60) Provisional application No. 60/251,309, filed on Dec. 4, 2000.
(60) Provisional application No. 60/261,328, filed on Jan. 12, 2001.

(51) Int. Cl. G06F 17/60

(52) U.S. Cl. 705/14

(57) ABSTRACT

According to one embodiment, a feature rich advertisement, such as a banner advertisement, provides consumers with a mechanism for finding, requesting or authorizing the sending of additional information related to the products or services advertised. For example, the advertisement can allow a consumer to request an e-mail including the information pertaining to the advertised products or services. Additionally, the consumer can request e-mail be forwarded to friends or other acquaintances. The consumer can also request additional information be directed toward his or her browser, including, for example, some or all information related to the promotion of the advertisement, additional information on promotional offerings, products or services from the provider of the advertisement, the advertiser, a partnering company of the same, or the like.

### REFERENCE TO RELATED APPLICATIONS

The present application is a continuation-in-part of U.S. patent application Ser. No. 09/825,772, filed Apr. 4, 2001, entitled “SYSTEM AND METHOD FOR PROVIDING REQUEST BASED CONSUMER INFORMATION,” (the “parent application”) and claims priority benefit under 35 U.S.C. §120 to the same. Moreover, the present application claims priority benefit under 35 U.S.C. §119(e) from U.S. Provisional Application No. 60/261,328, filed Jan. 12, 2001, entitled “SYSTEM AND METHOD OF DELIVERING INTERACTIVE ADVERTISEMENTS IN THE FORM OF BANNER ADVERTISEMENTS.” The present application incorporates the foregoing disclosures herein by reference.

The parent application claims a priority benefit under 35 U.S.C. §119(e) from U.S. Provisional Application No. 60/194,530, filed Apr. 4, 2000, entitled “SYSTEM AND METHOD FOR PROVIDING SELECTIVE AUTHORIZATION FOR THE DISSEMINATION OF INFORMATION,” U.S. Provisional Application No. 60/252,446, filed Nov. 21, 2000, entitled “SYSTEM AND METHOD FOR ORGANIZING AND ACCESSING CONSUMER INFORMATION THROUGH BARCODES,” U.S. Provisional Application No. 60/251,309, filed Dec. 4, 2000, entitled “METHOD OF MARKETING COMPUTING DEVICES THROUGH DISSEMINATION OF BUSINESS AND PROMOTIONAL MATERIALS HAVING SCANNABLE INDICIA,” and U.S. Provisional Application No. 60/261,328, filed Jan. 12, 2001, entitled “SYSTEM AND METHOD OF DELIVERING INTERACTIVE ADVERTISEMENTS IN THE FORM OF BANNER ADVERTISEMENTS,” which are all incorporated herein by reference.

### FIELD OF THE INVENTION

The present invention relates to the field of electronic commerce. More specifically, the invention relates to feature rich advertisements.

### BACKGROUND OF THE INVENTION

As the popularity of the Internet and the World Wide Web has increased over the years, more and more companies are seeking effective advertising solutions in order to promote their products to consumers. One such advertising solution includes the pushing of advertisements to consumers through banners or e-mail. Banner advertisements often include various types of multimedia information, including simple images, which promote products, services, websites, or the like. Although banner advertisements are presented in a wide number of shapes and sizes, they are often shaped similar to a rectangular “banner” anchored to a section of a particular website. When a consumer visits the website, the banner advertisement is pushed to the consumer along with the other information associated with the site. Examples of banner advertisements appear on virtually every commercial Web site on the Internet.

On the other hand, e-mail advertisements include various types of multimedia information formatted into an e-mail message. The consumer's e-mail address is often gathered through a wide number of methods, not all of which are known to, or approved by the consumer. The e-mail address is attached to the e-mail advertisement, and the e-mail is delivered to the consumer. Examples of unsolicited e-mail advertising campaigns are often referred to as online junk mail, or simply spam.

Because of the ineffectiveness of pushing random information to consumers through banner or e-mail advertisements, revenues received from the sale of same continue to decline. Accordingly, online advertisers have applied related concepts of matching, tracking, and predicting, to the information found in these delivery mechanisms. For example, online advertisers may attempt to profile types of consumers who visit a particular website. The profile may be based on the online content of the website, self-reported demographic information of a consumer, or consumer tracking. Self-reported demographic information may include areas of interest, income, occupation, age, race, sex, marital status, or the like. Consumer tracking may include recording information about consumer purchases, preferences, or activities, and sending the information back to the online advertising company. Consumer tracking is often accomplished through the use of small files, or cookies, typically stored on a consumer's computer that retain information about the consumer's purchases, preferences, activities, or the like.

Once the online advertisers create the foregoing consumer profiles, they use the profiles to predict or match which products or services the advertisers believe might be interesting to the consumers. Advertisement information associated with the matched products or services is then pushed to the consumer through the foregoing delivery vehicles of banner or e-mail advertisements.

Another solution by online advertisers attempting to overcome the ineffectiveness of pushing random information to consumers, is the use of opt-in e-mail. Generally, opt-in e-mail allows a consumer to agree to receive e-mail advertisements based on a broad authorization of a topic or category of information. The online advertiser then determines which information to push to the consumer based on the topic or category. For example, a consumer may authorize an advertiser to send e-mail relating to sales or closeouts. In response, the advertiser may push, via e-mail, closeout pricing information for any item the advertiser selects, based on, for example, the foregoing matching, tracking, or predicting solutions.

Unfortunately the foregoing advertising solutions include a number of drawbacks for consumers and online advertisers. For example, the foregoing solutions often result in an unwelcome and unnecessary invasion of privacy for consumers who provide personal demographic information to online advertisers or whose activities are tracked by the same. Additionally, the foregoing solutions cause consumers to assume some risk associated with non-encrypted electronic transmissions of personal information, as well as the potential for the advertiser to transfer or sell gathered information without the consent of the consumer. For example, although many online companies adopt privacy policies purporting to restrict the use of private information gathered through the foregoing tracking, self-reporting, or the like, some of these companies abruptly change their policy due to, for example, the perceived market value of the forgoing personal information. Thus, through use of the foregoing solutions, the consumer often assumes the risk that the company will sell or otherwise provide the consumer's personal information to others, often without consumer consent or even consumer knowledge of the same.

In addition to the foregoing drawbacks, consumers using the foregoing advertising solutions are often peppered with unwanted information contained in inappropriate banner ads, continuous pop-up windows or unsolicited e-mail. Such unwanted information wastes consumer time and may unwittingly anger otherwise interested customers.

The foregoing advertising solutions also include a number of disadvantages for the advertisers. For example, online advertisers may find that unsolicited banner or e-mail advertisements are costly to produce and disseminate, and are generally ineffective because the vast majority of consumers have little or no interest in the products or services contained therein. In addition, as disclosed in the foregoing, consumers may build a negative perception of a particular company or for commercial e-mail campaigns generally, based on, for example, unsolicited or ineffective e-mail campaigns. Moreover, advertisers who experience poor results from often expensive advertising campaigns may be less inclined to participate in any online advertising.

Embodiments of the present invention seek to overcome some or all of these and other problems.

### SUMMARY OF THE INVENTION

Therefore, a need in the industry exists for an effective way to target online consumer information to consumers who actually want to use the product or services offered therein. Accordingly, one aspect of the invention includes a system and method for effectively targeting consumer information to consumers who want to use various product or services. Moreover, another aspect of the invention includes a system and method for matching vendors to those consumers who want information about specific products or services sold, offered, or otherwise made available by the vendor.

According to one embodiment, a feature rich advertisement, such as a banner advertisement, provides consumers with a mechanism for finding, requesting or authorizing the sending of additional information related to the products or services advertised. For example, the advertisement can allow a consumer to request an e-mail including, for example, the information pertaining to the advertised products or services. Additionally, the consumer can request an e-mail be forwarded to a friend or other acquaintance. The consumer can also request additional information be directed toward his or her browser, including, for example, some or all information related to the subject of the banner advertisement, additional information on promotional offerings, products or services from the provider of the banner advertisement, the advertiser, a partnering company of the same, or the like.

According to another embodiment, the feature rich advertisement can be used to generate revenue for the provider thereof based on actions of the consumers who view the same. By providing multiple revenue generating actions, advertisers and feature rich advertisement providers can adjust the revenues to reflect the effectiveness of the advertisement. For example, the revenue generated from an unsolicited presentation can differ from that of a specific consumer requested notification, which may differ still from an advertisement resulting in a sale or the sale to a competitor. A revenue process advantageous provides the provider of feature rich advertisements, such as a request based marketing system, to assess the advertiser some or all of the foregoing fees based on same or all of the foregoing consumer actions and/or selections.

According to one embodiment, a request based marketing system provides request based consumer information to consumer computing devices through a communications network, such as the Internet. The request based marketing system includes one or more portal servers accessing a consumer information database, a subscription database, and a product information database.

Therefore, one aspect of an embodiment of the invention includes a feature rich advertisement to be displayed on a consumer computing device. The feature rich advertisement comprises ad space including one or more promotions to be displayed on a consumer computing device, and at least one request option selectable by a consumer, the request option providing that information associated with the one or more promotions will be delivered via e-mail to an e-mail address entered or confirmed by the consumer.

Another aspect of an embodiment of the invention includes a method of providing feature rich advertisements having consumer selectable requests allowing a consumer to request that information corresponding to a supplier's promotion be delivered to an e-mail address designated by the consumer. The method comprises providing a feature rich advertisement including promotional information to a web page loaded into a browser of a consumer computing device, receiving a consumer selected request for information related to the promotional information, the consumer selected request designating at least one e-mail address, and sending the information to the at least one e-mail address via e-mail.

Yet another aspect of an embodiment of the invention includes a method of generating revenue from actions associated with a feature rich advertisement displayed on a consumer computing device. The method comprises assessing a transaction fee when a consumer purchases a product from a promotion in an e-mail requested by one of the consumer or an acquaintance of the consumer from a feature rich advertisement displayed on a consumer computing device and assessing a notification fee when the consumer receives the e-mail. The method also comprises assessing a click-through fee when the consumer uses the e-mail to request additional information about the promotion.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 illustrates an exemplary block diagram of an interactive consumer information delivery system, according to aspects of an embodiment of the invention;

FIG. 2 illustrates a flow chart of delivery process, according to aspects of an embodiment of the invention;

FIG. 3 illustrates an exemplary block diagram of a portal server system of the delivery system of FIG. 1, according to aspects of an embodiment of the invention;

FIG. 4 illustrates a filtering process executed by a filtering module of the portal server system of FIG. 3, according to aspects of an embodiment of the invention;

FIG. 5A illustrates a subscription process executed by a subscription module the portal server system of FIG. 3, according to aspects of an embodiment of the invention;

FIG. 5B illustrates an exemplary block diagram of hierarchically organized request services, according to aspects of an embodiment of the invention;

FIG. 6 illustrates a formatting process executed by a formatting module of the portal server system of FIG. 3, according to aspects of an embodiment of the invention;

FIG. 7 illustrates a population process executed by a database population module of the portal server system of FIG. 3, according to aspects of an embodiment of the invention;

FIG. 8 illustrates an exemplary web page including a feature-rich advertisement, according to aspects of an embodiment of the invention;

FIG. 9 illustrates the exemplary web page of FIG. 8 after the feature-rich advertisement has been activated, according to aspects of an embodiment of the invention;

FIG. 10 illustrates a requesting process providing consumers the ability to request additional information through the feature-rich advertisement of FIG. 8, according to aspects of an embodiment of the invention; and

FIG. 11 illustrates a revenue process illustrating revenue generation available to, for example, the provider of the advertisement of FIG. 8, according to aspects of an embodiment of the invention.

### DETAILED DESCRIPTION OF THE PREFERRED EMBODIMENT

An interactive consumer information delivery system (“delivery system”) includes a request based marketing system (“marketing system”). According to one embodiment, the marketing system can provide feature rich advertisements that allow consumers to, for example, request specific product or service information be sent to them, an acquaintance, or both, via, for example, e-mail. Additionally, the feature rich advertisements can redirect, for example, consumer browsers to some or all information related to the subject of the advertisement, additional information on promotional offerings, products or services from the marketing system, actual suppliers or vendors, a partnering company of the same, or the like.

According to one embodiment, consumers can recognize the feature rich advertisements by identifying indicia placed on or near the banner. For example, the identifying indicia may include a mark, an interactive symbol, or the like, identifying the advertisement as offering additional request based services. According to a preferred embodiment, the identifying indicia comprises a cube. According to another preferred embodiment, the identifying indicia comprises an animated cube, such as a spinning cube made of the letter “E,” identifying eMe, Inc. as at least one of the provider companies or partners of the marketing system.

An embodiment of the feature rich advertisement can include additional revenue models for generating revenue for, for example, the provider of the advertisement, such as, for example, the marketing system. For example, typical banner advertisements generate a fee for the seller of the same when, for example, the advertisement is shown to a viewer of a website. The feature rich advertisement can generate revenue for the provider of the same when, for example, the consumer requests e-mail for himself or herself, for an acquaintance, when the e-mail is received, read, or both, when one or more of the foregoing views additional information related to the subject matter of the advertisement, when one or more of the foregoing view additional information from the marketplace provider or partners of the same, or the like.

According to additional embodiments, the marketing system provides a wide variety of consumer information to a consumer who has requested or authorized delivery of the consumer information for specific products or services. According to another embodiment, the marketing system organizes the consumer information for a particular product or service into a number of request services, such as, for example, “Discounts,” “Comparisons,” “New Releases,” “Catalogs,” or the like. Because the consumer may subscribe to a particular set of request services corresponding to particular products or services, the marketing system advantageously provides highly customized consumer information to those consumers who actually want to receive it.

According to yet another embodiment, the marketing system provides a potential or actual advertiser with an effective online marketing solution. For example, according to one embodiment, the advertiser submits specific product or service information, along with consumer information related to each product or service. The marketing system advantageously organizes the consumer information into one or more request services, and supplies the consumer information to those consumers who have subscribed to the one or more request services. Alternatively, the marketing system may advantageously gather product or service information, along with consumer information related to the same, and contact a potential advertiser as consumers subscribe to the foregoing consumer information. By allowing the consumer to authorize or subscribe to various request services for a particular product or service, the marketing system advantageously matches advertisers to those consumers most interested in the advertisers' products or services.

To facilitate a complete understanding of the invention, the remainder of the detailed description describes aspects and embodiments of the invention with reference to the figures, wherein like elements are referenced with like numerals throughout.

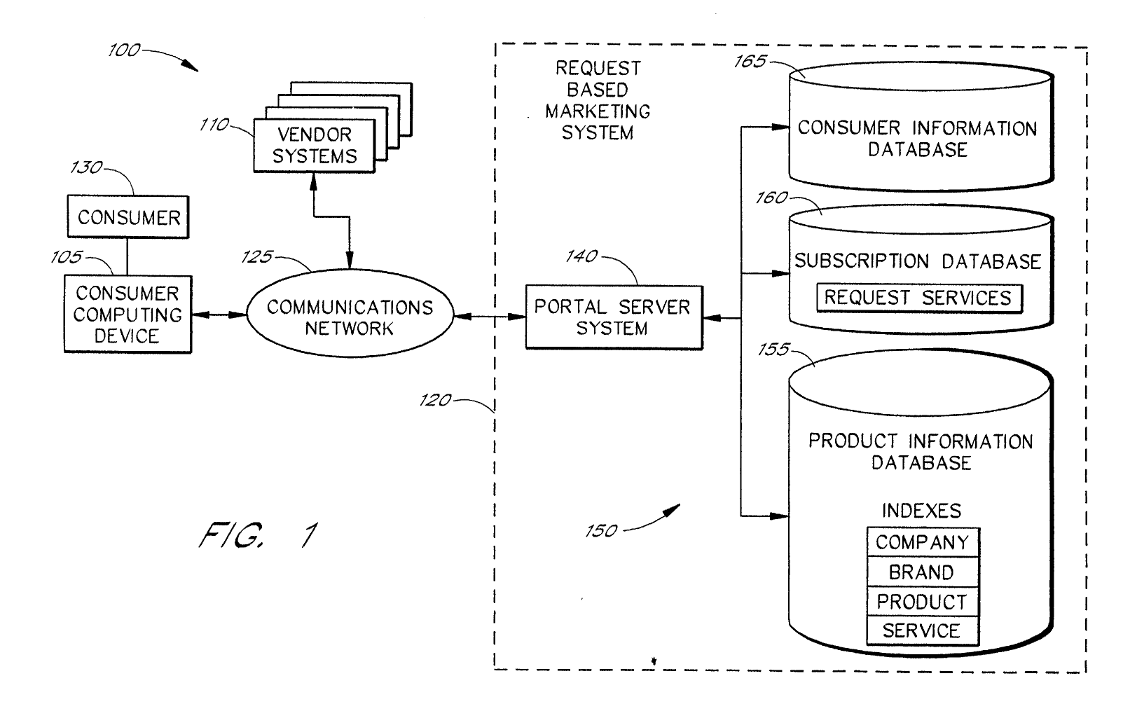

FIG. 1 illustrates an exemplary block diagram of an interactive consumer information delivery system (“delivery system”) 100, according to aspects of an embodiment of the invention. As shown in FIG. 1, the delivery system 100 comprises a consumer computing device 105, one or more vendor systems 110, and a request based marketing system (“marketing system”) 120, communicating with one another through a communications network 125.

According to one embodiment, the delivery system 100 provides a consumer 130 with a variety of consumer information corresponding to one or more products or services (“products”) offered by a virtually limitless number and type of manufactures, suppliers, resellers, retailers, etailers, distributors, wholesalers, service providers, professionals, or the like (“vendors”). For example, according to one embodiment, a particular vendor may register one or more of his or her products with the marketing system 120. In addition, the vendor may supply a wide variety of consumer information for each of the listed products, such as, for example, information regarding discounts, comparisons with other products, new releases of the product, catalogs, or the like. The marketing system 120 advantageously associates or organizes the supplied consumer information into corresponding request services, such as, for example, “Discounts,” “Comparisons,” “New Releases,” “Catalogs,” or the like. Now, when the consumer 130 determines he or she is interested in one or more of the listed products, the marketing system 120 allows the consumer 130 to subscribe to one or more request services associated with the product. The marketing system 120 then advantageously formats a deliverable having the consumer information corresponding to the one or more subscribed-to request services, and delivers the deliverable to the consumer 130.

Based on the foregoing, the delivery system 100 delivers that portion of the consumer information corresponding to the consumer designated product. Therefore, the delivery system 100 advantageously targets consumer information about a particular product, to those consumers who actually want to use, or are otherwise interested in, that product. Thus, the consumer 130 advantageously avoids the aggravation of receiving unwanted solicitations, while the vendor, or advertiser, advantageously avoids wasting resources sending random information to consumers not necessarily interested therein.

According to another embodiment, the marketing system 120 may advantageously gather the foregoing information about vendor products and the consumer information corresponding thereto, from a wide number of online sources, such as, for example, the one or more vendor systems 110. For example, the marketing system 120 may use software programs, often called Internet bots or spiders, to recognize and read information available on the World Wide Web, and send product information as well as consumer information to the marketing system 120. Then, according to one embodiment, when the consumer 130 subscribes to one or more request services corresponding to the gathered product information, the marketing system 120 may advantageously contact a vendor, provide data pertaining to, for example, the number of consumers requesting a particular type of consumer information related to the vendor's product, and thereby form partnering or other arrangements for providing consumer information related to that vendor's products. Thus, the marketing system 120 advantageously recruits advertisers to employ the delivery system 100 to perform their online advertising campaigns. Moreover, the marketing system 120 advantageously provides specific feedback regarding the type of consumer information desired by the consumer 130.

According to yet another embodiment, the marketing system 120 provides the consumer 130 with the ability to filter and organize product information. For example, according to one embodiment, the marketing system 120 allows the consumer 130 to organize product information by one or more search constraints, such as, for example, “Companies,” “Brands,” “Products,” “Services,” or the like. For example, the consumer 130 may advantageously desire consumer information, such as discounts, about his or her favorite brand. By selecting the search constraint “Brand,” the consumer 130 may view product information by, for example, thousands of popular brands, such as, “Delta Airlines” “Guess?,” “Marriott,” “Maytag,” “Pizza Hut,” “Sony,” “Trek,” or the like. According to one embodiment, the marketing system 120 may advantageously further filter product information into one or more topics having one or more subtopics. For example, the brand “Guess?” may advantageously include the topics of, for example, “Clothing,” “Glasses,” “Shoes,” “Watches,” or the like. Moreover, the particular topic “Clothing,” may include the subtopics of, for example, “Logo Tee-Shirts,” “Short Sleeve Shirts,” “Long Sleeve Shirts,” “Sweaters,” “Sweatshirts,” “Jeans,” “Shorts,” or the like. Thus, the marketing system 120 advantageously allows the consumer 130 to efficiently and effectively filter product information to those specific products he or she is most interested in.

As disclosed in the foregoing, the marketing system 120 also allows the consumer 130 to organize product information by the search constraint of, for example, “Products.” Although “Products” may include topics and subtopics of products, similar to “Brands,” the “Products,” constraint may include some portion of the North American Industry Classification System (NAICS) categories. For example, the marketing system 120 may organize the product information into topics of, for example, “Electronics,” “Kitchenware,” “Music,” “Sporting Goods,” or the like. “Services” may advantageously include professional designations, such as, for example, “Dentists,” “Doctors,” “Electricians,” “Mechanics,” or the like.

Although the marketing system 120 may organize and filter product information as disclosed in foregoing, a skilled artisan will recognize from the disclosure herein that a large number of search constraints subdivided into a large number of topics and subtopics may advantageously assist the consumer 130 in efficiently and effectively finding products he or she desires.

FIG. 1 also shows the delivery system 100 including the consumer computing device 105. According to one embodiment, the consumer computing device 105 may advantageously comprise virtually any device capable of interacting with the communications network 125 so as to receive and send electronic information thereto. Moreover, according to one embodiment, the consumer computing device 105 includes at least one input mechanism, such as, for example, a pointer, a keypad or keyboard, touch screen, or the like, allowing the consumer 130 to interact with the consumer computing device 105. According to one exemplary embodiment, the consumer computing device 105 comprises a processor, memory, the foregoing input-output mechanism, an operating system, and a communications protocol, such as, for example, a TCP/IP stack, for establishing communication with the communications network 125.

Although the consumer computing device 105 is disclosed with reference to the foregoing embodiments, the system is not intended to be limited thereby. Rather, a skilled artisan will recognize from the disclosure herein a wide number of alternative embodiments of the consumer computing device 105. For example, the consumer computing device 105 may individually, or in various combinations, comprise a personal computer, computer system or work station, an interactive television, an interactive kiosk, a personal mobile computing device, a digital assistant, a mobile phone, a laptop, or the like. In such alternative systems, the operating systems will likely differ and be adapted for the particular computing device. However, according to one embodiment, the operating system advantageously continues to provide the appropriate communications protocols needed to establish communication between the consumer computing device 105 and the communications network 125.

FIG. 1 also illustrates the delivery system 100 including the one or more vendor systems 110. According to one embodiment, the vendor systems 110 comprise virtually any computing device capable of connecting the vendor to the marketing system 120 through the communications network 125. For example, the vendor system 110 may advantageously include any individual or combination of the devices disclosed with reference to the consumer computing device 105. Moreover, the vendor system 110 may advantageously include a website accessible through, for example, the Internet, and designed to produce information about a particular vendor's products.

FIG. 1 also illustrates the delivery system 100 including the communications network 125. According to one embodiment, the communications network 125 comprises the Internet. The structure of the Internet, which is known to those of ordinary skill in the art, includes a network backbone with networks branching from the backbone. However, one of ordinary skill in the art will recognize from the disclosure herein that the communications network may comprise individually or in various combinations, a private, local, or wide area network, one or more wireless, optical, or satellite connections, telephone or communication networks, or the like. Moreover, the consumer computing device 105, the one or more vendor systems 110, and the marketing system 120, may individually or in combination connect to the communications network 125 through conventional Internet service providers, such as, for example, dial-up modem connections, digital subscriber lines, cable modems, fiber connections, dedicated servers, wireless systems or the like.

FIG. 1 also illustrates the delivery system 100 including the marketing system 120. According to one embodiment and as shown in FIG. 1, the marketing system 120 comprises a portal server system 140 connected to one or more databases 150. According to one embodiment, the one or more databases 150 may advantageously include a product information database 155, a subscription database 160, and a consumer information database 165.

According to one embodiment, the portal server system 120 comprises one or more servers communicating with the one or more databases 150 and the communications network 125. According to one embodiment, the portal server system 120 may advantageously serve electronic documents, run back-end applications, manage communication with the one or more databases 150, or the like.

The marketing system 120 also includes the product information database 155. According to one embodiment, the product information database 155 stores product information relating to the products from one or more vendors. The product information may advantageously include a wide number of listings for a wide number of companies, products, brands, services, or the like. Moreover, according to one embodiment, the product information may advantageously include some information corresponding to the product, such as, for example, product specifications, marketing information, or the like.

According to one embodiment, the product information database 155 also includes one or more indexes, such as, for example, indexes on companies, brands, products, services or the like. The indexes advantageously provide quick access to pre-organized product information. Thus, according to one embodiment, the portal server system 140 may access the product information stored in the product information database 155, and thereby receive data organized by, for example, a particular company, a particular brand, a particular product, a particular service, or the like.

As disclosed in the foregoing, the marketing system 120 also includes the subscription database 160. According to one embodiment, the subscription database 160 stores information relating a particular consumer to one or more request services. The request services advantageously comprise subject areas or categories, and sub-subject areas or subcategories of consumer information for, for example, each product listed in the product information database 155. The consumer 130 may advantageously subscribe to one or more of the foregoing subject areas for a particular product, and receive the consumer information corresponding thereto. For example, a request service may comprise discounts, such as sales, coupons, and rebates, or comparisons, such as prices, policies, or opinions, or new releases, such as, planned releases or future prototypes, or information, such as news, locations, and support. Moreover, the request services may include consumer information for a particular product available through catalogs, or for the obtaining of catalogs, or special offers such as offers for participation in surveys, offers for participation in focus groups, or samples made available for providing feedback. Thus, as the consumer 130 reviews products the marketing system 120 produces from the product information database 155, the consumer 130 may desire to subscribe to one or more request services corresponding to a particular product. For example, the consumer may subscribe to planned new releases for a particular brand of a particular product.

Although the request services are disclosed with reference to its preferred embodiments, the disclosure is not intended to be limited thereby. Rather, a skilled artisan will recognize from the disclosure herein a wide number of alternatives subject areas and sub-subject areas for organizing the consumer information.

FIG. 1 also shows the marketing system 120 having the consumer information database 165. As disclosed in the foregoing, the consumer information database 165 stores consumer information. Consumer information may advantageously include a wide number of varying information generally related to particular products. For example, consumer information may include virtually any information relevant to a particular product, such as, for example, news, commentary, testimonials, references, specifications, features, advantages, marketing materials, opinions, reviews, surveys, focus group results or studies, industry reports or comparisons, sales, coupons, specials, product retail locations, maps, technical support, help links, customer service, activation or deactivation, assembly instructions, owners manuals, product or service histories, warrantees, rebates, or the like. According to one embodiment, some or all of the consumer information may include information that changes on a very frequent basis (“dynamic information”), such as, for example, price, sale campaigns, new release information, warrantees, rebates, or any of the types of information disclosed in foregoing with reference to the static consumer information. According to this embodiment, the marketing system 120 may advantageously update the dynamic information periodically, at consumer-specified intervals, some or each time the consumer information is accessed, from time to time, or the like.

According to one embodiment, the foregoing consumer information is organized to correspond to one or more of the request services. Thus, when the portal server system 140 determines that the consumer 130 has subscribed to a particular request service, the portal server system 140 may advantageously access the consumer information database 165 and deliver the consumer information corresponding to the particular subscribed-to request service.

Thus, according to the foregoing embodiments, the marketing system 120 advantageously stores product information from one or more vendors in the product information database 155, where the product information is organized by one or more of a variety of indexes. Moreover, the marketing system 120 advantageously stores in the consumer information database 165, consumer information corresponding to each of the products stored in the product information database 155 and advantageously organizes the consumer information into one or more of the request services. In addition, the marketing system 120 tracks consumer subscriptions to the one or more request services, and delivers the appropriate subscribed-to, or authorized consumer information to the consumers requesting the same.

Although the one or more database 150 are disclosed with reference to their preferred embodiments, the disclosure is not intended to be limited thereby. Rather, a skilled artisan will recognize from the disclosure herein a wide number of alternative storage solutions for the product information, the consumer information, or the information relating particular consumers to their subscribed-to request services. For example, the information may be stored in a single database, multiple databases in the same or geographically remote locations, multiple databases using data mirrors, partial data mirrors, or the like, or different physical or logical organizations of the foregoing information.

In addition to the foregoing, one embodiment of the marketing system 120 advantageously avoids placing consumers in the position of having to assume the risk of unwanted disclosure or sale of personal information. According to one embodiment where consumer information is e-mailed to the consumer 130, the marketing system 120 collects the consumer' e-mail address, a name by which the consumer wishes to be written to, and the various request services for products, to which the consumer subscribes. Moreover, according to one embodiment, when the consumer 130 desires to make an online purchase of one or more products, the marketing system 120 places the consumer 130 in contact with the appropriate vendor or vendor system 110, thereby avoiding the collection of any personal or otherwise private information. Thus, the consumer 130 can be assured that the entity controlling the marketing system 120 will not misuse private information, because, according to one embodiment, the marketing system 120 does not request or otherwise store such information.

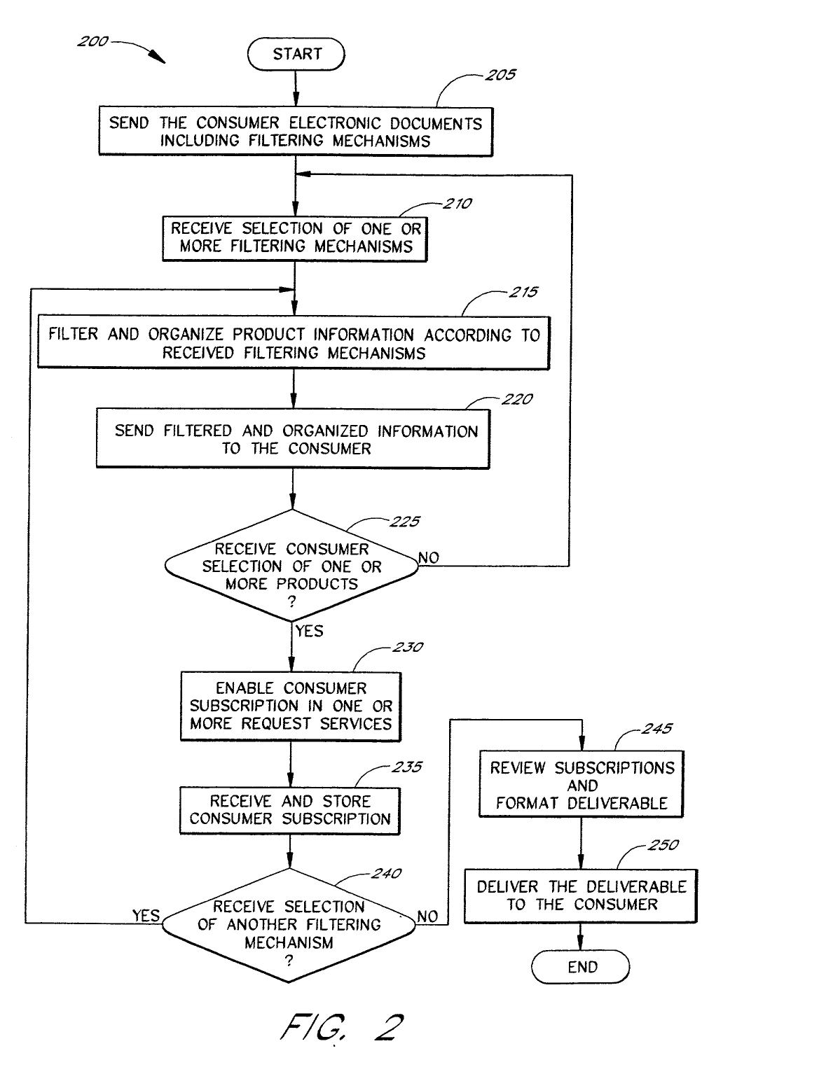

FIG. 2 illustrates a flow chart of a delivery process 200 for delivery of request based consumer information, according to an embodiment of the system. As shown in FIG. 2, the delivery process 200 begins with Block 205 where the marketing system 120 sends the consumer 130 one or more electronic documents having one or more filtering mechanisms. According to one embodiment, the one or more filtering mechanisms allow the consumer 130 to specify how the marketing system 120 will organize and filter the product information to be sent to the consumer 130, thereby allowing the consumer 130 to quickly and efficiently find specific products, about which they wish to receive consumer information. According to one embodiment, the filtering mechanism may include the ability to browse topically and subtopically organized product information, brand or company organized product information, product or service organized product information, or the like. According to another embodiment, the filtering mechanism may include searching, such as, for example, entering search criteria into natural language or binary search engines, and receiving result or hit lists.

According to yet another embodiment of the system, the filtering mechanism may include developing search constraints, such as, for example, selectable pull down menus or check boxes for instructing the marketing system 120 how the information is to be organized for the consumer 130. For example, according to one embodiment, the consumer 130 may advantageously choose a first level search constraint from a pull down menu or checkbox, which produces a set of second level search constraints on a pull down menu, each of which may produce a set of third level search constraints, and so on. For example, the consumer 130 may select from the search constraints of, for example, “Companies,” “Brands,” “Products,” “Services,” or the like. Moreover, the consumer 130 may then choose a second level search constraint from a pull down menu or checkbox of, for example, a first letter of, for example, the selected company, selected brand, selected product, selected service, or the like. The consumer 130 may then advantageously choose a third level search constraint from a pull down menu or checkbox of, for example, a particular company, brand, product, service, or the like. For example, the consumer 130 may select the search constraint “Company,” the search constraint “A,” the search constraint “Apple,” and the search constraint “Power Macs,” thereby filtering the product information into that information listing types of Power Macs available from Apple Computer, Inc.

After the consumer chooses from the foregoing one or more filtering mechanisms, the delivery process 200 continues to Block 210, where the marketing system 120 receives the consumer selection of the one or more filtering mechanisms. The delivery process 200 continues to Block 215 where the marketing system 120 filters and organizes the product information according to the received filtering mechanisms. The delivery process 200 then continues to Block 220 where marketing system 120 sends the filtered and organized product information to the consumer 130.

The delivery process 200 continues to Decision Block 225 where the marketing system 120 receives the selection of one or more products from the product information sent to the consumer 130. According to one embodiment, when the marketing system 120 does not receive a selection of any of the products from the product information sent to the consumer 130, the delivery process 200 returns to Block 210 and waits to receive a selection of another filtering mechanisms. Thus, the delivery process 200 advantageously allows the consumer 130 to select a particular filtering mechanism, and then browse through the product information by continuing to select other filtering mechanisms until finding one or more products, in which the consumer 130 is interested.

At Decision Block 225, when the marketing system 120 does receive a selection of one or more particular products, the delivery process 200 continues to Block 230 where the marketing system 120 enables consumer subscription to the one or more request services. For example, according to one embodiment, the marketing system 120 may advantageously provide a request service subscription mechanism (“subscription mechanism”) which guides the consumer 130 through subscribing to one or more of the request services for a particular product. For example, the subscription mechanism may advantageously comprise a graphical user interface (GUI), electronic documents containing checkboxes, pull down menus and submenus, applets, scripts, or the like, which guide the user through subscribing to various request services. According to one embodiment, the subscription mechanism may be transmitted to, or may already be residing on, the consumer computing device 105.

According to another embodiment, the marketing system 120 may provide electronic forms or documents, which allow the consumer 130 to select one or more request services. For example, the electronic forms or documents may include one or more check boxes or check box groups for allowing the consumer to specifically subscribe to one or more of the request services.

The delivery process 200 continues to Block 235, where the marketing system 120 receives and stores subscriptions to the one or more request services. According to one embodiment of the system, the marketing system 120 stores the consumer subscriptions in the subscription database 160.

The delivery process 200 then proceeds to Decision Block 240, where the marketing system 120 may receive a selection of another filtering mechanism from the consumer 130. When the marketing system 120 receives such a selection, the delivery process 200 returns to Block 215 where the marketing system 120 filters and organizes the product information from, for example, the product information database. Thus, the delivery process 200 advantageously provides the consumer 1030 with the ability to subscribe to the one or more request services for a particular product, and then proceed to other products using the same or other filtering mechanisms.

On the other hand, when the marketing system 120 does not receive another selection of a filtering mechanism at Decision Block 240, the delivery process 200 continues to Block 245, where the marketing system 120 reviews the information in the subscription database 160 and consumer information database 165, and then formats one or more deliverables. For example, the marketing system 120 may advantageously determine whether changes have occurred to the dynamic consumer information in the consumer information database 165, such as, for example, changes in price, new releases, news, or the like. According to one embodiment, when changes exist, the marketing system 120 may advantageously format a deliverable with the changed consumer information, which, at Block 250, is then sent to the particular consumer.

However, a skilled artisan will recognize from the disclosure herein a wide number of alternatives, outside of a change to the dynamic information, which may advantageously trigger the formatting and delivery of the deliverables. For example, the marketing system 120 may format deliverables at consumer specified intervals, when new consumer information arrives in the consumer information database 165, when the consumer 130 subscribes to particular request services, periodically, from time to time, or the like.

According to one embodiment, the deliverable may advantageously comprise an e-mail, regular mail, a page, a telephone or mobile phone call or message, a message to the consumer computing device, or the like. Moreover, according to one embodiment, the deliverable may advantageously include information allowing the consumer 130 to begin a transaction, be transported to the one or more vendors 110, or subscribe to additional request services. For example, the deliverable may advantageously include commercial transaction commands, such as, hyperlinks, enabling the consumer 130 to order or otherwise purchase the one or more products for which the deliverable was created. According to one embodiment, the commercial transaction may advantageously occur with a vendor on the vendor system 110. According to another embodiment, the marketing system 120 may advantageously act as a broker for the commercial transaction between the vendor and the consumer 130. According to yet another embodiment, the consumer 130 may transact directly with the marketing system 120.

In addition to the foregoing, the deliverable may advantageously include transport commands, such as, for example, hypertext, thereby connecting the consumer computing device 105 with a vendor of the one or more products for which the deliverable was created. According to one embodiment, the deliverable may direct the consumer computing device 105 to the marketing system 120, and the marketing system 120 may serve electronic documents from the vendor system, such as, for example, framed documents from partnering vendors. According to yet another embodiment, the deliverable may provide the consumer 130 with the ability to request addition consumer information, such as, for example, subscribing to additional request services offered by the marketing system 120.

Based on the foregoing, the delivery process 200 advantageously allows a consumer to filter through a potentially large volume of product information, and to subscribe to particular request services corresponding to a particular product, thereby receiving consumer information corresponding to the request service. Thus, the delivery process 200 allows the consumer to specifically authorize advertisers to deliver select information about select products in which he or she has interest, rather than receive less effective random or pseudo-random information from advertisers.

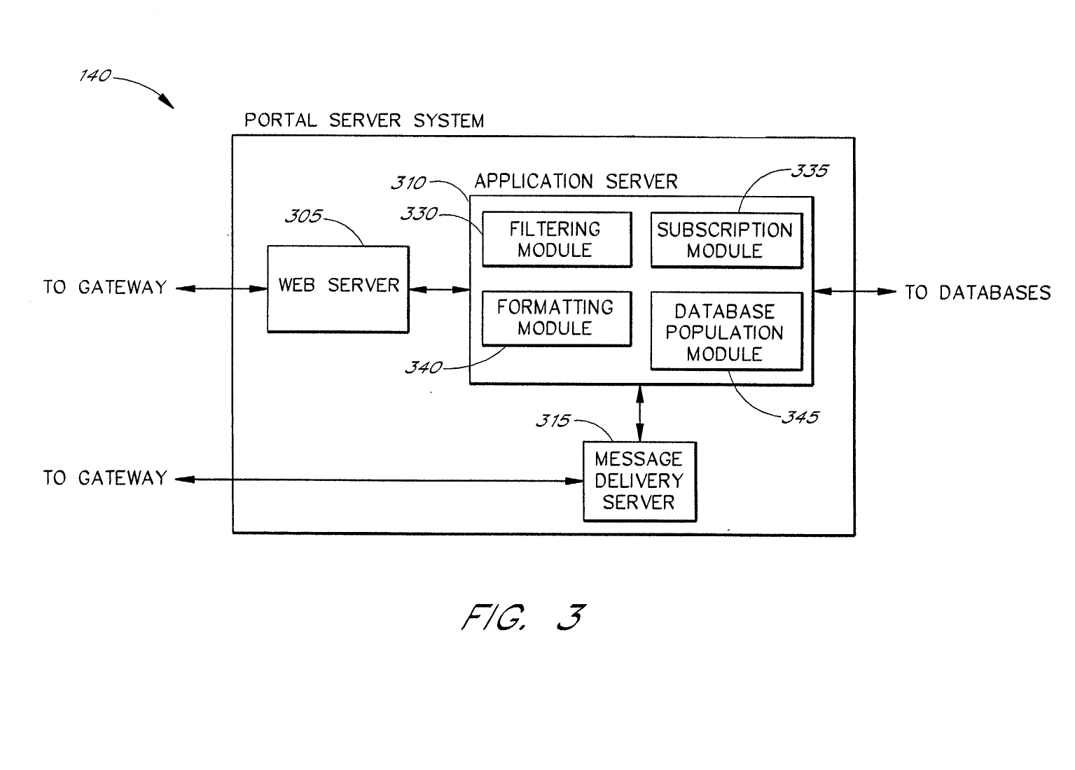

FIG. 3 illustrates an exemplary block diagram of the portal server system 140 of FIG. 1, according to aspects of an embodiment of the system. As shown in FIG. 3, the portal server system 140 comprises a web server 305, an application server 310, and a message delivery server 315. According to one embodiment, the web server 305 comprises one or more conventional web servers, such as, for example, those commercially available from Apache, Linux, Microsoft, or the like. The web server 305 may advantageously serve electronic documents to the consumer computing device 105, including, for example, static or active server pages, or the like. Moreover, the web server 305 may advantageously receive and send information over the communications network 125 in, for example, HTML, XML, or other known Internet data formats. Moreover, the web server 305 may advantageously communicate with the application server 310.

According to one embodiment, the application server 310 comprises one or more conventional application servers, such as, for example, those commercially available from Apache, Linux, Microsoft, or the like. According to one embodiment, the application server 310 includes one or more applications or software modules, providing at least some of the functionality of the marketing system 120, along with translation of requests and commands between, for example, browser based systems to back-end business applications or databases. For example, the application server 310 may include software programs converting information and commands from conventional markup languages, to, for example, standard query languages (SQL). Moreover, the application server 310 communicates with the message delivery server 315 in order to format, for example, deliverables having consumer information.

As disclosed in the foregoing, according to one embodiment, the application server 310 includes software programs or modules, which provide at least some of the functionality of the marketing system 120. According to one embodiment, the software modules of the application server 310 comprise a filtering module 330, a subscription module 335, a formatting module 340, and a database population module 345. According to one embodiment of the system, the filtering module 330 includes software for providing the filtering mechanisms disclosed with reference to FIG. 2. For example, the filtering module may allow the consumer 130 to govern the organization and filtering of the product information through, for example, browsing, searching, application of relational constraints, or the like.

According to one embodiment, the subscription module 335 includes software designed to allow the consumer 130 to subscribe to one or more of the request services. Moreover, the formatting module 340 includes software designed to format one or more types of deliverables having consumer information corresponding to subscribed-to request services. In addition, according to one embodiment, the database population module 345 comprises software designed to populate the one or more database 150 with the product and consumer information.

Although the application server 310 is disclosed with reference to its preferred embodiment, the invention is not intended to be limited thereby. Rather, a skilled artisan will recognize from the disclosure herein a wide number of software modules and business applications that may reside on the application server 310. For example, the application server 310 may advantageously include one or more e-commerce modules, providing functionality for commercial transactions. Moreover, the application server 310 may include mapping modules designed to provide locations and maps corresponding to, for example, various request services. According to one embodiment, the mapping modules may advantageously poll one or more of the vendor systems 110, such as, for example, partnering vendors which provide mapping data, such as, for example, data commercially available from Mapquest.

FIG. 3 also shows the portal server system 140 having the message delivery server 315. According to one embodiment, the message delivery server 315 may advantageously comprise one or more e-mail exchange servers designed to multicast e-mail messages to lists of consumer e-mail addresses, a paging system designed to provide consumer information, such as reminders or the like in the form of pages, or virtually any system capable of delivering specific consumer information to the consumer computing device 105. According to another embodiment, the message delivery server 315 may provide voice mail or other communications to the consumer 130.

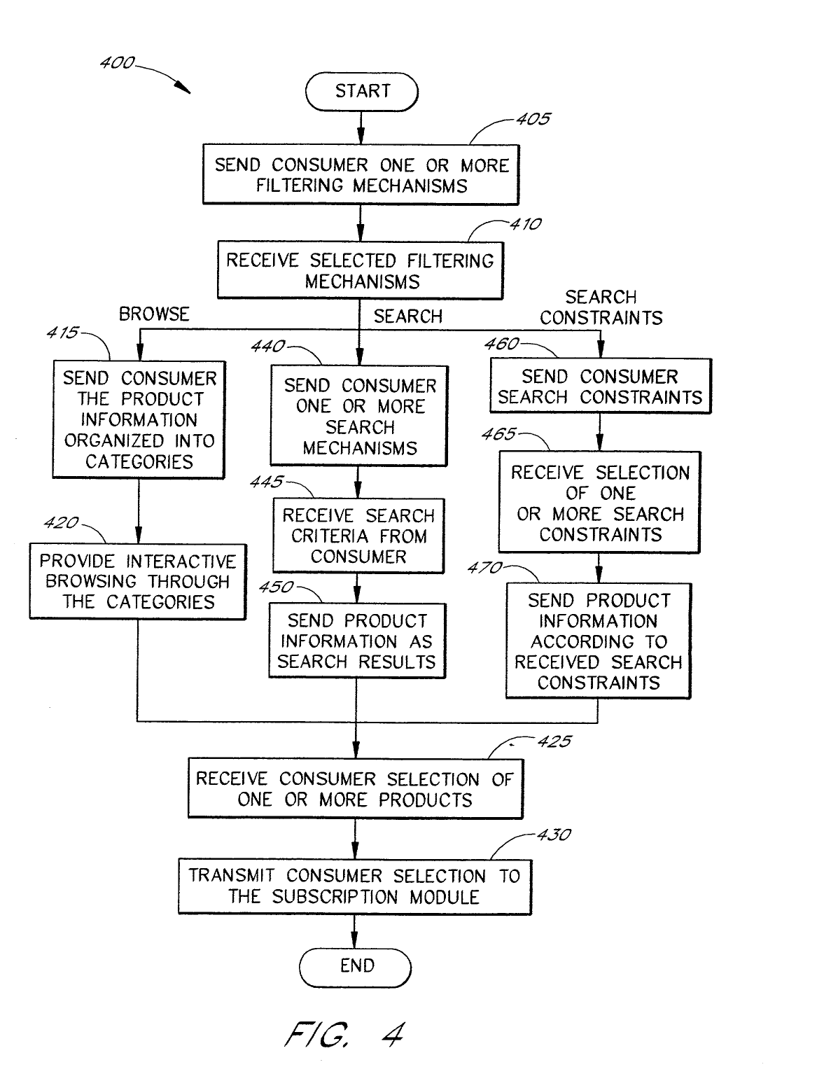

FIG. 4 illustrates a filtering process 400 executed by the filtering module 330, according to aspects of an embodiment of the system. According to one embodiment, the filtering process 400 allows the consumer 130 to govern the organization and filtering of the product information. For example, as shown in FIG. 4, the filtering process 400 begins with Block 405 where the marketing system 120 sends one or more filtering mechanisms to the consumer computing device 105. As disclosed in the foregoing, the filtering mechanisms may advantageously provide the functionality of browsing, searching, or the application of one or more search constraints.

According to one embodiment, when the consumer 130 has determined or selected one or more filtering mechanisms, the selection is received by the filtering module 330 in Block 410. When the filtering mechanism selected by the consumer 130 includes browsing-type functionality, the filtering process 400 proceeds to Block 415 where the filtering module 330 sends the product information from the product information database 155 to the consumer computing device 105. According to this embodiment, the product information is organized into categories, many of which have subcategories and so on, such as, for example, the type of information organization used by many current websites, such as, for example, Yahoo.com.

The filtering process 400 then proceeds to Block 420, where the filtering module 330 interacts with the consumer computing device 105 to provide interactive browsing of the categories and subcategories of product information. According to one embodiment, once the consumer 130 selects one or more particular products from a category or subcategory, the selection is received by the filtering module 330 at Block 425. According to another embodiment, the filtering module 330 then transmits, at Block 430, a message to the subscription module 335, indicating the consumer selection of the one or more particular products.

On the other hand, when the filtering module 330 receives the consumer selected filtering mechanism at Block 410, and the selection includes searching functionality, the filtering process 400 proceeds to Block 440 where the filtering module 330 sends a search mechanism to the consumer 130. As disclosed in the foregoing, the search mechanism may include, for example, binary or other term-combinable text searching mechanisms, natural language search engines, or the like. Once the filtering module 330 receives, at Block 445, one or more search criteria selected by the consumer through the search mechanism, the filtering process 400 proceeds to Block 450 where the filtering module 330 sends the product information as results or hits from the search criteria being applied to the product information. According to one embodiment, when the consumer 130 selects one or more products from the search results, the filtering process 400 proceeds to Block 425 where the filtering module 330 receives the consumer selection.

When the filtering module 330 receives the consumer selected filtering mechanism at Block 410, and the selection includes search constraints, the filtering process 400 proceeds to Block 460 where the filtering module 330 sends one or more search constraints to the consumer computing device 105. According to one embodiment, the filtering module 330 may provide the search constraints in the form of pull down menus or the like. According to one embodiment, after the consumer 130 selects the one or more search constraints found in the, for example, pull down menus, those search constraints are sent to the filtering module 330 at Block 465 of the filtering process 400. Thereafter, the filtering module 330, at Block 470, sends the product information matching the received one or more search constraints. According to one embodiment, when the consumer 130 selects one or more products from the product information organized by the search constraints, the filtering process 400 proceeds to Block 525 where the filtering module 330 receives the consumer selection.

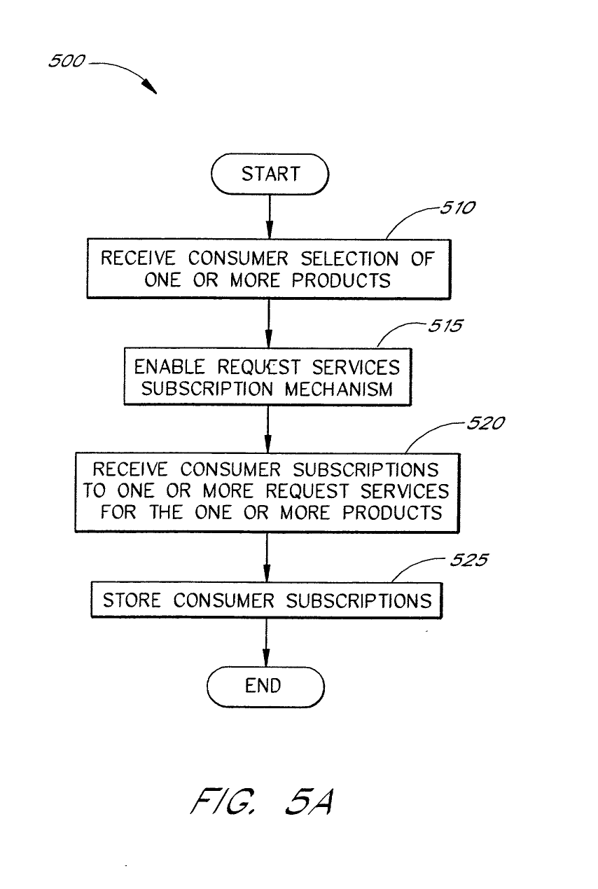

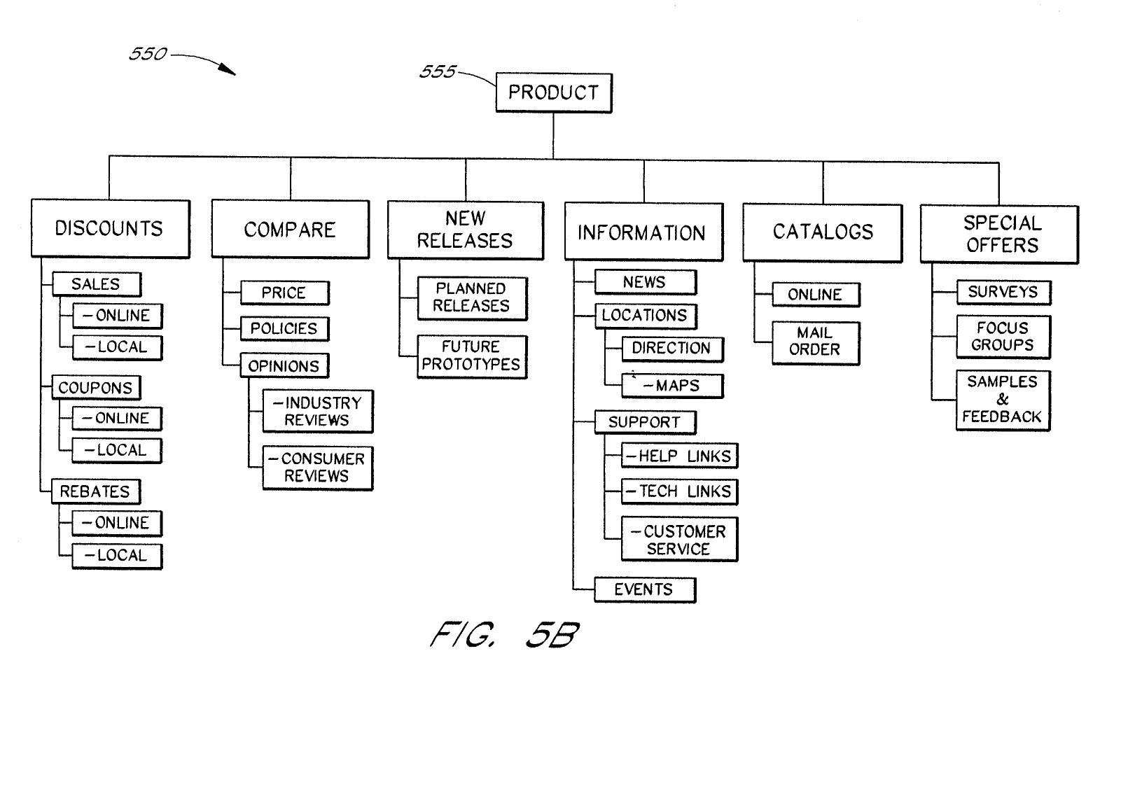

FIG. 5A illustrates a subscription process 500 executed by the subscription module 335 of the application server 310, according to aspects of an embodiment of the system. As shown in FIG. 5A, the subscription process 500 begins in Block 510 when the subscription module 335 receives a consumer selection of one or more products from the product information sent to the consumer by the filtering module 330. According to one embodiment, the subscription process 500 proceeds to Block 515 where the subscription module 335 enables the request services subscription mechanism. As disclosed in the foregoing, the subscription mechanism may advantageously include a scripting or otherwise client-resident software program executing on the consumer computing device 105 to guide the consumer 130 in subscribing to one or more of the request services corresponding to the selected product. Alternatively, as disclosed in the foregoing, the subscription mechanism may advantageously comprise one or more electronic forms or documents having, for example, check boxes, groups of check boxes, pull down menus, or the like, guiding the consumer 130 through the subscription to one or more of the request services.

According to one embodiment, once the consumer 130 interacts with the subscription mechanism to record the consumer's subscriptions, the subscription process 500 continues to Block 520 where the subscription module 335 receives the consumer subscriptions from the subscription mechanism. The subscription process 500 continues to Block 525, where the subscription module 335 stores the consumer subscriptions in, for example, the subscription database 160.

FIG. 5B illustrates an exemplary block diagram of hierarchically organized request services 550, according to aspects of an embodiment of the system. As shown in FIG. 5B, the request services 550 for a particular product 555 may advantageously comprise hierarchically organized subject areas or categories and subcategories relating to the product 555. For example, the request services 550 may be organized into, for example, categories such as “Discounts,” “Comparisons,” “New Releases,” “General Information,” “Catalogs,” “Special Offers,” or the like. Moreover, as shown in FIG. 5B, each of the foregoing categories may further be organized into a wide number of continually more specific areas of interest.

Although the request services 550 are disclosed with reference to their preferred embodiment, the system is not intended to be limited thereby. Rather, a skilled artisan will recognize from the disclosure herein a wide number of alternatives for the request services 550. For example, as shown in FIG. 5B and according to one embodiment, the request services 550 may include various additional consumer-specified parameters. For example, according to one embodiment, the request services 550 include the category of “Events.” Thus, when the consumer 130 selects, for example, movies, live shows, concerts, sports teams, celebrities, musicians, comedians, or the like, as the product 555, the consumer 130 may advantageously subscribe to receive consumer information on, for example, events surrounding a particular one of the forgoing list.

Moreover, according to one embodiment, the consumer 130 may additionally enter parameters, such as, for example, defining time or date windows, venues, or the like, within which the consumer 130 wishes to receive consumer information pertaining to the particular event. For example, the consumer 130 may subscribe to receive show times and locations for, for example, the particular live shows occurring at a specific venue, during weekend evenings, for the next month. Additionally, the consumer 130 may subscribe to request services providing maps, reservation information, or the like. Thus, the request services 550 advantageously allow consumers to specify specific types of consumer information they wish to receive for the specific products they have chosen. Moreover, according to one embodiment, consumers may advantageously further designate parameters, such as, for example, the frequency of delivery, delivery when the consumer information reaches a threshold, such as, for example, a threshold price, a date range, a delivery schedule, an action by a supplier of the consumer information, an action by the consumer, or the like. The parameters advantageously further define the types of consumer information that the marketing system 120 will deliver. Thus, the marketing system 120 allows consumers to authorize with varying degrees of specificity, the type of consumer information they wish to receive for the products they select.

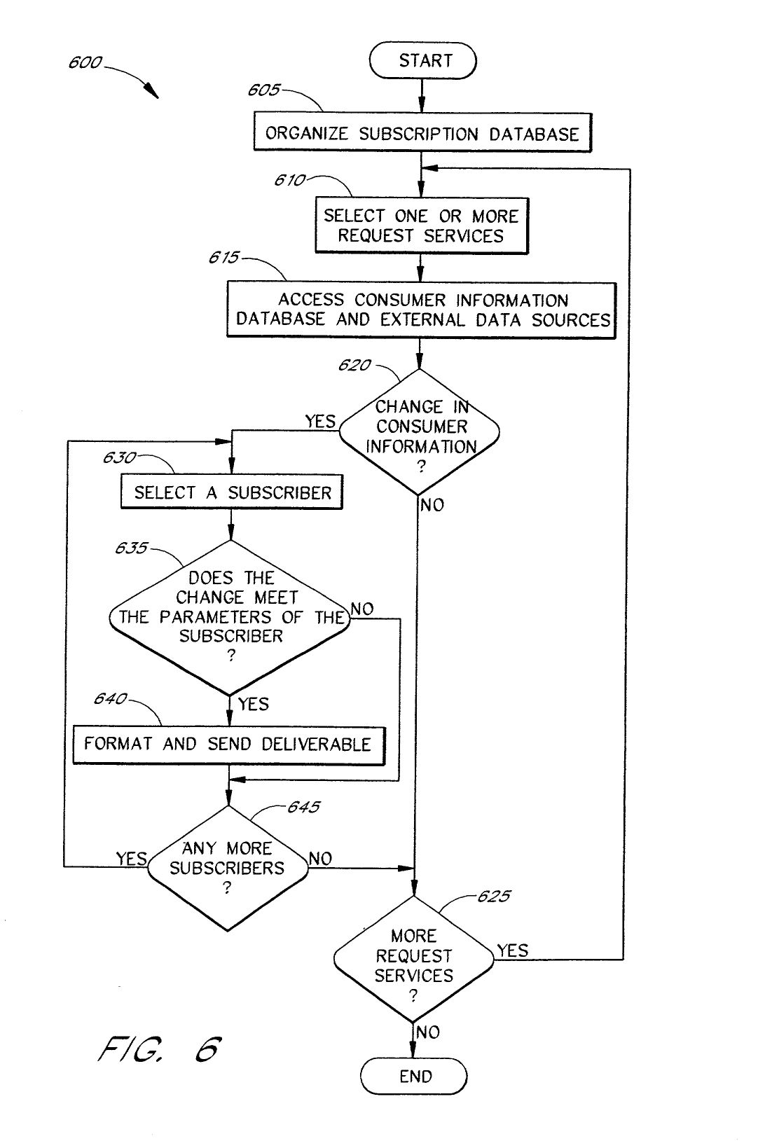

FIG. 6 illustrates a formatting process 600 executed by the formatting module 340 of the application server 310, according to aspects of an embodiment of the system. As shown in FIG. 6, the formatting process 600 begins at Block 605, when the formatting module 340 accesses and organizes the subscription database 160. According to one embodiment, the formatting module 340 may advantageously organize the subscriptions in the subscription database according to, for example, the origin of the consumer data corresponding to each request service. For example, according to one embodiment, the consumer information for a particular product from a particular vendor may include coupons, price, news, opinions, and the like, all organized into their respective request services. Moreover, the marketing system 120 may also recognize that according to this embodiment, the foregoing consumer information is acquired from the vendor system 110 of the particular vendor. Thus, according to one embodiment, the formatting module 340 may advantageously organize the request services such that the marketing system 120 polls the vendor system 110 for updated consumer information a minimum number of times. However, a skilled artisan will recognize from the disclosure herein that the subscriptions in the subscription database 160 may advantageously be organized by a wide number of parameters, including, for example, a particular product, a particular source of the corresponding consumer information, by request service, or the like.

After the subscription database is organized, the formatting process 600 proceeds to Block 610 where the formatting module 340 selects one or more of the request services. As disclosed in the foregoing, the formatting module 340 may group the request services by a particular product, a particular source of the corresponding consumer information, by request service, or the like. For the one or more selected request services, the formatting module 340, at Block 615, accesses the consumer information stored in the consumer information database 165 corresponding to the selected request services. According to one embodiment, the formatting module 340 also accesses any external data sources of that consumer information. For example, the formatting module 340 may request from the one or more vendor systems 110, any updated consumer information corresponding to the request services.

The formatting process 600 then proceeds to Decision Block 620, where the formatting module 340 determines whether the consumer information corresponding to the selected request services has changed. When the consumer information has not changed, the formatting process 600 proceeds to Decision Block 625, where the formatting module 340 determines whether there are any more request services. When there are more request services, the formatting process 600 returns to Block 610 and selects another group of request services. When, at Decision Block 625, there are no more request services, the formatting process 600 ends.

When the formatting module 340, at Decision Block 620, determines that the consumer information has changed, the formatting process 600 proceeds to Block 630, where the formatting module 340 selects a subscriber to the one or more selected request services. The formatting module 340 then, at Decision Block 625, determines whether the changes to the consumer information meet the parameters of the particular subscriber. For example, when the consumer 130 subscribes to the one or more request services, the consumer 130 may advantageously include a wide number of parameters for the consumer information corresponding to each request. For example, the consumer 130 may subscribe to the request service of pricing information, and only want to be notified when the price of the corresponding product is below a certain limit. According to this example, the formatting module 340 at Block 635 advantageously compares the changed consumer information, e.g., the price, and determines whether the new price meets the price parameter of the subscribing consumer. When it does, the formatting module 340 formats a deliverable and delivers it to the consumer 130.

As disclosed in the foregoing, the deliverable may advantageously include virtually any message, such as, for example, a notice, an alarm, a reminder, or the like, to the consumer 130, including an e-mail, a regular mail, a page to, for example, a pager, a personal digital assistant (“PDA”), a telephone or mobile phone, or the like, a telephone or mobile phone call or message, or the like. Alternatively, the deliverable may include an indication that the consumer 130 should review a particular website that advantageously posts the deliverables for consumer review. Although the deliverable is disclosed with reference to various embodiments, a skilled artisan will recognize a wide number of possible deliverable formats from the disclosure herein. Moreover, according to an embodiment, the formatting module 340 sends the deliverable by forwarding it to the message delivery server 315 of the portal server system 140.

After formatting and sending the deliverable, the formatting module 340 determines, at Block 645, whether there are any more subscribers to the selected one or more request services. When there are more subscribers, the formatting process 600 proceeds to Block 630 where the formatting module 340 selects another subscriber. When there are not, the formatting process 600 proceeds to Decision Block 625 where the formatting module 340 determines whether there are more request services.

According to one embodiment, at Decision Block 635, when the changed consumer information does not meet the parameters of the subscriber, the formatting process 600 proceeds to Decision Block 645 where the formatting module 340 determines whether there are more subscribers. Thus, the formatting module 340 through the formatting process 600 advantageously accesses subscription information in order to send that consumer information corresponding to consumer-entered parameters to the consumers who subscribed to the same.

According to one embodiment, the formatting module 340 may execute the formatting process 600 in response to a wide number of events. For example, the formatting module 340 may execute the formatting process 600 when additional consumer information is added to the consumer information database 165 from a particular vendor, Internet bot, or spider, when a subscriber subscribes to one or more of the request services 550, from time to time, periodically, at a consumer-specified date or time, or the like.

Although the formatting process 600 is disclosed with reference to its preferred embodiment, the invention is not intended to be limited thereby. Rather, a skilled artisan will recognize from the disclosure herein a wide number of alternatives for formatting process 600, such as, for example, the formatting process 600 may advantageously gather all subscribed-to consumer information for a particular consumer into one deliverable to be sent to the same. Alternatively, the formatting process 600 may advantageously gather all deliverables before sending any of the same. Moreover, a skilled artisan will recognize from the disclosure herein that the formatting process 600 may include portions of some or all of the embodiments disclosed in the foregoing.

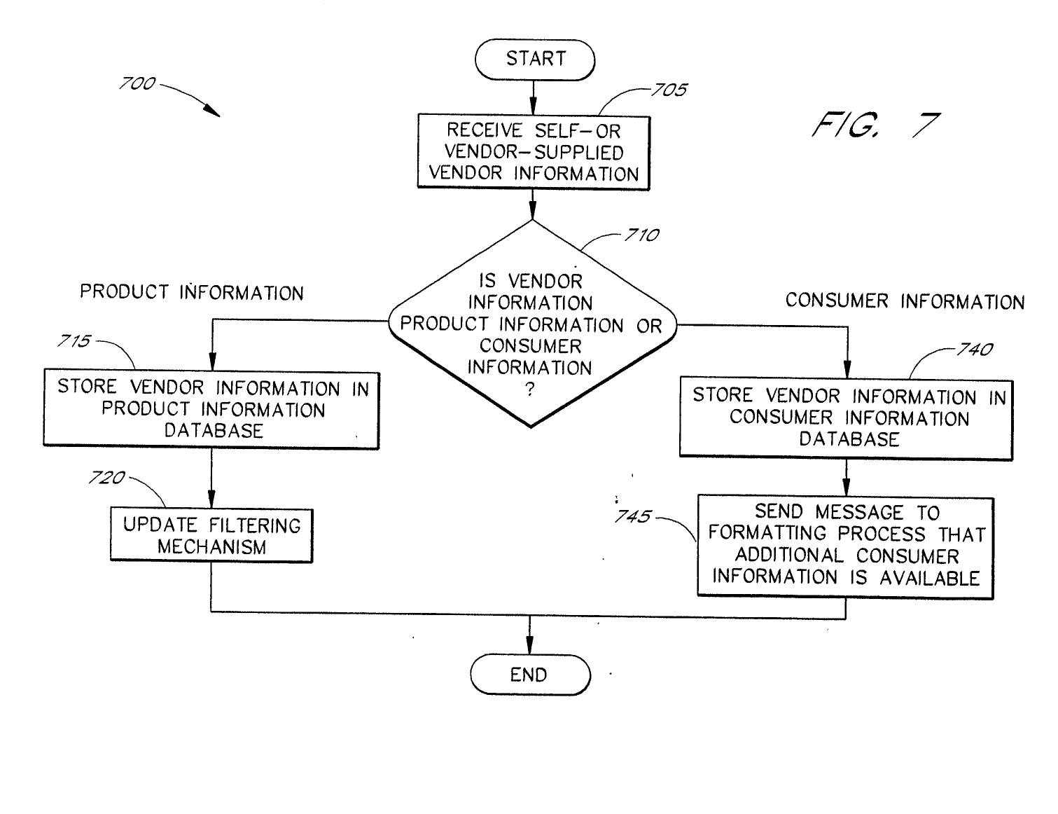

FIG. 7 illustrates a population process 700 executed by the database population module 345 of the application server 310, according to aspects of an embodiment of the system. As shown in FIG. 7, the population process 700 begins with Block 705 where the database population module 345 receives self- or vendor-supplied vendor information. According to one embodiment, self-supplied vendor information may comprise information gathered through, for example, an Internet bot or spider which accesses a wide number of websites and gains information based on criteria provided thereto. For example, a skilled artisan will recognize numerous conventional spiders or crawling software programs designed to gather information from the World Wide Web and send the information back to the originator or owner of the bots or spiders. Thus, according to one embodiment, the marketing system 120 may advantageously send Internet bots or spiders throughout the World Wide Web to collect product information and, for each product, corresponding consumer information.

Alternatively, the marketing system 120 may be operated by an entity which enters into agreements with various vendors, such that the vendors through, for example, the vendor systems 110, supply vendor information to the marketing system 120. According to one embodiment, the vendors may advantageously designate which vendor information corresponds to product information, and which corresponds to consumer information. According to another embodiment, the marketing system 120 may recognize the distinctions between the types of vendor information.

The population process 700 then proceeds to Decision Block 710 where the database population module 345 determines whether the vendor information is product information or consumer information. As mentioned in the foregoing, according to one embodiment, this determination may advantageously come from the supplier of the vendor information. When the vendor information is product information, the population process 700 proceeds to Block 715 where the database population module 345 stores the vendor information in the product information database 155. At Block 720, the database population module 345 then updates the filtering mechanisms, such as, the foregoing disclosed search constraints to reflect or account for the new product information. Moreover, according to one embodiment, the database population module 345 may advantageously update the indexes of the product information database 155, such as, for example, the indexes for “Companies,” “Brands,” or the like, in order to properly accommodate the new vendor information.

According to one embodiment, at Decision Block 710, the population process 700 may determine that the vendor information corresponds to consumer information. When the vendor information corresponds to consumer information, the population process 700 continues to Block 740, where the database population module 345 stores the vendor information in the consumer information database. For example, the database population module 345 may organize or otherwise associate the consumer information with one or more of the request services 550. The population process 700 then proceeds to Block 745 where the database population module 345 sends a message to the formatting module 340 that additional consumer information is available.

Although the foregoing invention has been described in terms of certain preferred embodiments, other embodiments will be apparent to those of ordinary skill in the art from the disclosure herein, for example, the skilled artisan will recognize a wide number of implementations of the marketing system 120, including multiple servers or other systems potentially being geographically remote from one another. Moreover, the skilled artisan will recognize from the disclosure herein that the marketing system 120 may advantageously be executed on the consumer computing device 105 interacting with, for example, one or more of the vendor systems 110.

In addition, the foregoing delivery system 100 may advantageously be adapted to provide the consumer 130 with a wide number of alternative mechanisms for filtering product information, and subscribing to the request services 550. For example, the consumer 130 may communicate through the consumer computing device 105 with the marketing system 120 and directly supply the marketing system 120 with his or her chosen product. For example, the consumer 130 may advantageously scan indicia from a product, advertisement, or the like, then use the scanned information to supply the marketing system 120 with an indication of which products the consumer 130 is interested in. According to one embodiment, the consumer 130 may use a scanning device, such as a scanning pen or scanning enabled consumer computer device, such as those commercially available from Palm, Visor, Ipaq, Clie, or the like, to scan indicia such as a bar code from a product or an advertisement.

According to one embodiment, the product may be in a retail store and the scannable indicia may be on the sales tag. According to another embodiment, the scannable indicia may be printed in a magazine, on a website, on a business card, in a book of business listings such as the Yellow Pages, or the like. Thus, according to one embodiment, the consumer 130 may advantageously designate the product for which he or she wishes to receive consumer information from, for example, bar codes, other unique or non-unique alphanumeric codes, or the like, on products, product sales tags, advertisements, print media, websites, television commercials, or the like.

According to yet another embodiment of the invention, the consumer 130 may advantageously subscribe to some or all of the request services 550 from, for example, a product listing outside the marketing system 120. For example, the vendor may advantageously provide the consumer 130 with the ability to subscribe to one or more of the request services 550 for products shown on the vendor systems 110. For example, the vendor may advantageously employ, for example, a subscription mechanism as part of a banner advertisement, or other product listing, thereby allowing the consumer 130 to subscribe to one or more of the request services 550 corresponding to the product listed in the banner. For example, the subscription mechanism may advantageously include check boxes, pull down menus, or the like.

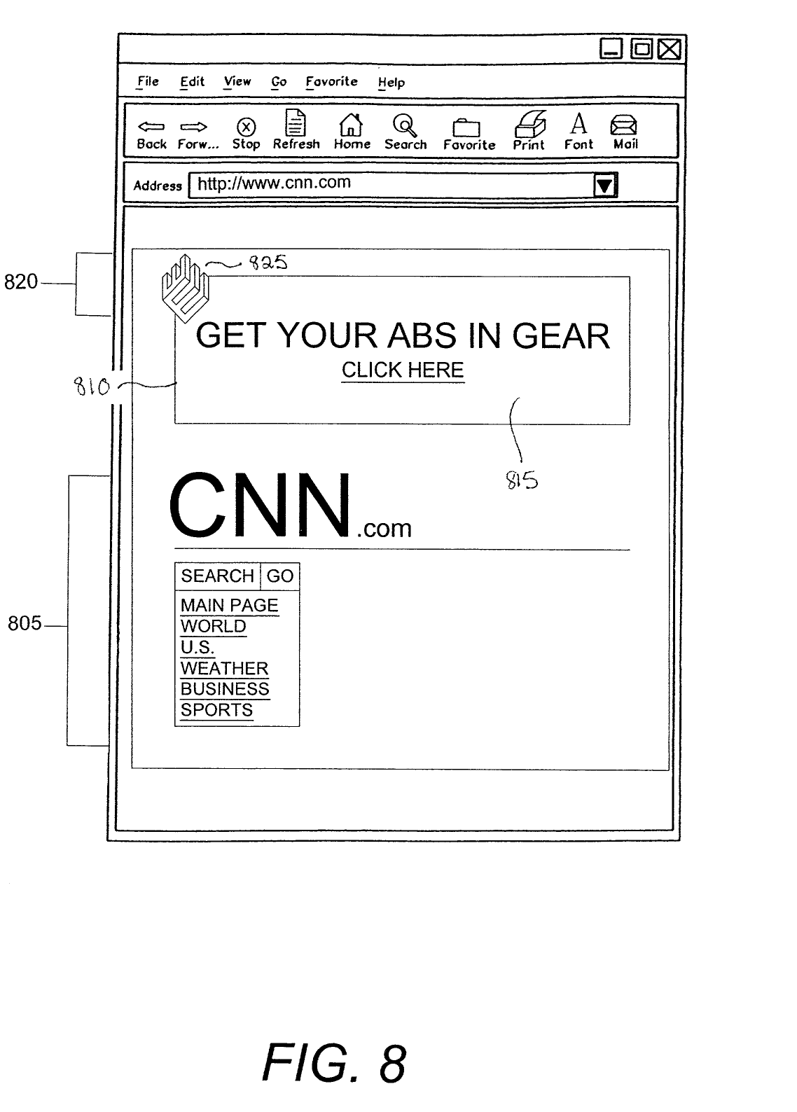

FIG. 8 illustrates an exemplary web page 800, according to aspects of an embodiment of the invention. As shown in FIG. 8, the exemplary web page 800 includes various electronic content 805 associated with a particular website, and an advertisement 810. For example, in the illustrated website, “CNN.com,” the electronic content 805 comprises content typically provided by CNN.com, such as, for example, menus for searching, main page news, world or U.S. news, weather, business or sports news or the like.

According to one embodiment, the advertisement 810 comprises a banner advertisement, which can also be presented in a wide number of shapes and sizes, can be positioned virtually anywhere on the web page 800, or animated on or throughout the same. The advertisement 810 can “float” on the web page 800 such that as the consumer scrolls through the electronic content 805, the advertisement 810, for example, remains in a position viewable on the web page 800. Additionally, the advertisement 810 may appear in a pop up, consistent or semi-consistent window, toolbar or the like. As shown in FIG. 8, the exemplary banner advertisement 810 is shaped similar to a rectangular “banner” anchored to a section of the web page 800.

According to one embodiment, the advertisement 810 includes ad space 815 and identifying indicia 820. As known to one of skill in the art, the ad space 815 can include various types of multimedia information, including simple text, images, animation, sound, embedded executable code or scripts, static or dynamic displays, or the like, which promote products, services, websites, or the like. Generally, the content and/or code for the ad space 815 is produced and sold by business entities other than the website provider. For example, the code that generates the content of the ad space 815 can include links that pull content from web servers connected through the communications network 125 while the website provider in the illustrated FIGURE can be CNN.com As shown in FIG. 8, the ad space 815 comprises simple text related to a promotion for getting the consumer 130 in better physical shape.

The identifying indicia 820 alerts consumers that the advertisement 810 includes feature rich functionality. In one embodiment, the identifying indicia 820 is placed on or near the banner. The identifying indicia 820 can include a mark, an interactive symbol, or the like. According to a preferred embodiment, the identifying indicia 820 comprises cube 825. According to another preferred embodiment, the identifying indicia 820 comprises an animated cube, such as, for example, spinning cube 825 made of the letter “E,” identifying eMe, Inc. as the provider of the advertisement 810.

According to one embodiment, the advertisement 810 includes a mechanism for activating some or all of the features of the feature rich advertisement 810. According to one embodiment, embedded code recognizes when the consumer 130 moves his or her cursor on the consumer computing device 105 over the advertisement 810 (“mouses-over”). However, a software programmer will recognize a number of consumer actions that can be used to activate the advertisement 810, including, for example, selection of the identifying indicia, or the like.

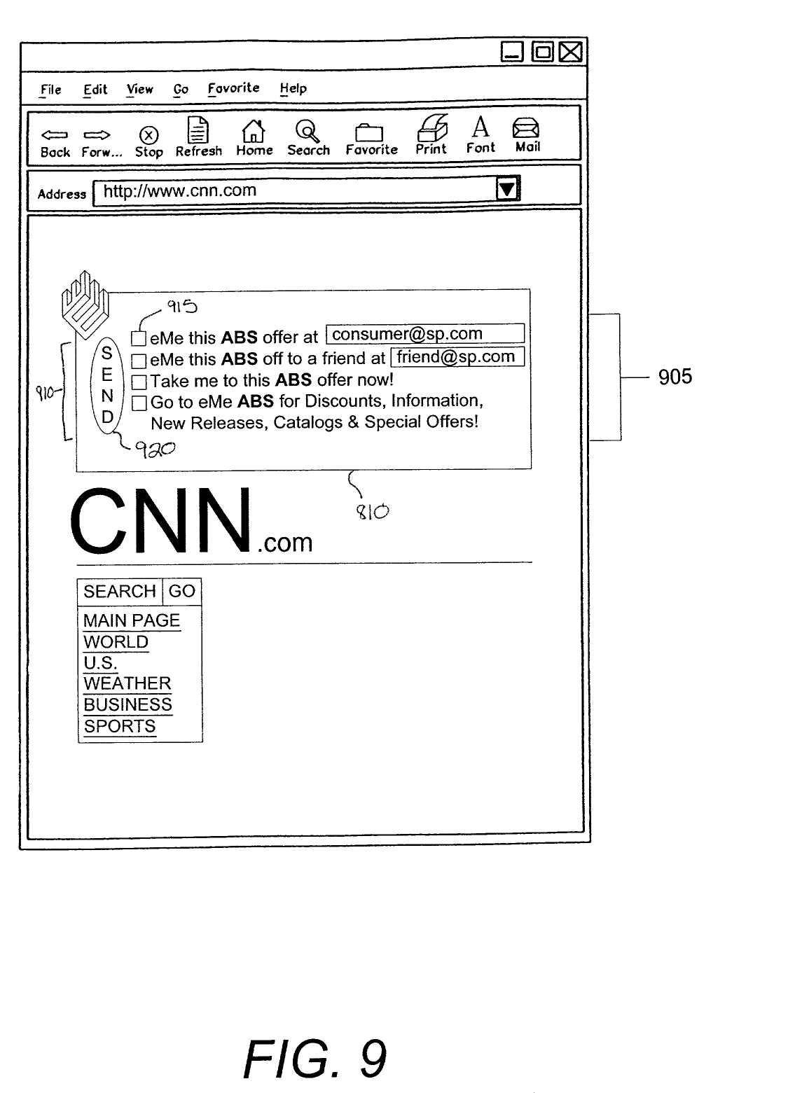

FIG. 9 illustrates the exemplary web page 800 after the feature rich advertisement 810 has been activated, according to aspects of an embodiment of the invention. As shown in FIG. 9, the advertisement 810 includes a number of request options 905, selectable by the consumer using selection mechanisms 910. The request options 905 can advantageously include a request for an e-mail of the advertisement, a request for an e-mail of the advertisement to be sent to one or more other e-mail addresses, redirection of the consumer's browser, a new window in the browser, or the like, to additional information related to the promotional offer in the advertisement 810, or redirection of the same to, for example, other consumer information related to the subject matter of the advertisement, such as, for example, discounts, information, new releases, catalogs, special offers, or the like.

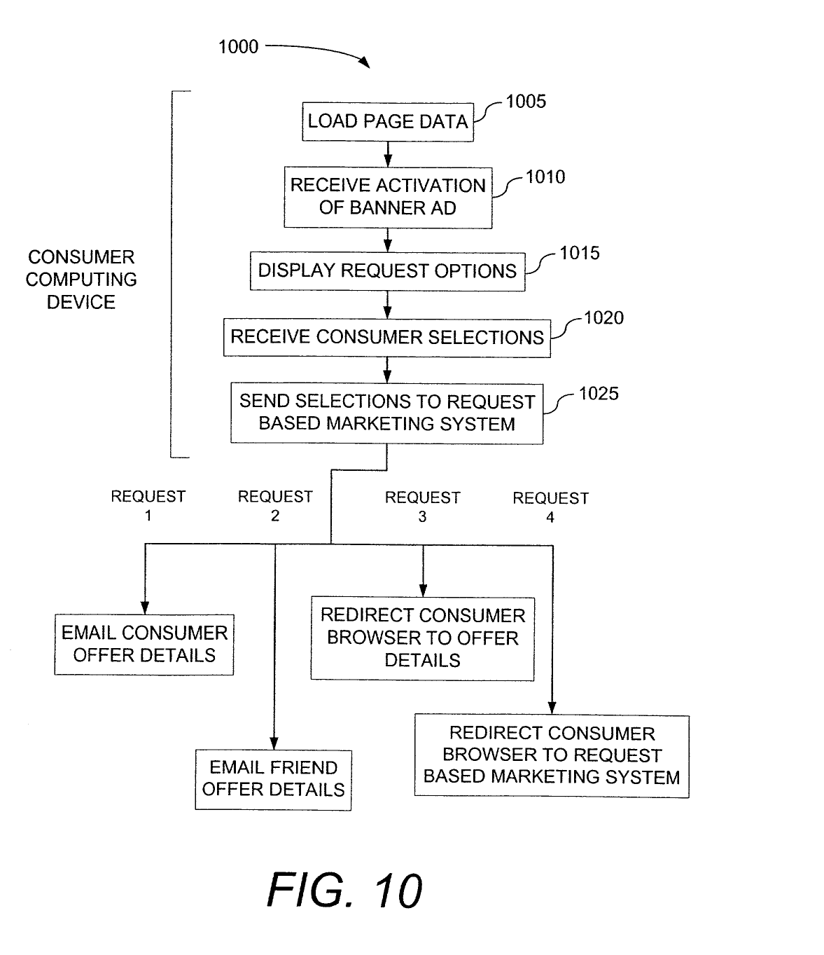

According to a preferred embodiment, the first and second request options allow the consumer to request an e-mail of the promotion be sent to his or her e-mail address, e-mail addresses of his or her friends or acquaintances or the like, or both. As shown in FIG. 9, the first request option can include a text box allowing the consumer to enter his or her preferred e-mail address. Additionally, the second request option can include one or more text boxes allowing the consumer to enter one or more e-mail addresses of his or her friends, or acquaintances. As will be discussed with reference to FIG. 10, the foregoing addresses may automatically loaded into the foregoing text boxes for consumer editing or acceptance.

Accordingly, the first and second request options provide advantages to all parties involved with a particular advertisement. For example, the first request option allows consumers to quickly and efficiently authorize the delivery of promotional information via email where such information is more likely to receive the attention it deserves. Moreover, the first request option allows advertisers to more effectively place advertisements relevant to a consumer's desires. Additionally, the provider of the advertisement can advantageously collect revenue on such effective directed request based advertisements.

According to the preferred embodiment, the third request option allows the consumer to request his or her browser be redirected to the promotion and/or additional information related to the promotion. Such redirection can occur in the currently active browser window, in non-active browser windows, or in newly created or popup browser windows. This option can correspond to what an artisan will recognize as the typical functionality of when a consumer selects a conventional advertisement. Accordingly, the third request option provides the advantages of conventional advertisements to consumers.

According to the preferred embodiment, the fourth request option allows the consumer to request his or her browser be redirected to, for example, the request based marketing system 120. As discussed with reference to the third option, the redirection can occur in the currently active browser window, in non-active browser windows, or in newly created or popup browser windows. Here, the consumer may take advantage of some or all of the functionality of request based marketing disclosed with reference to FIGS. 1-7. For example, the consumer may browse other products or services with the same or other BRANDS as the promotion, the same or other COMPANIES, or the like.

FIG. 9 also shows the request options be selectable through the selection mechanisms 910, such as, for example, checkboxes 915 and a submit button 920. Use of checkboxes advantageously allows the consumer 130 to select multiple request options before submitting the selections to the marketing system 120. However, a skilled artisan will recognize from the disclosure herein a wide variety of possible selection mechanisms, including hypertext, interactive buttons, pull-down menus, text boxes, or the like.

Based on the foregoing, the feature rich advertisement 810 advantageously allows a consumer to request specific information related to a promotional offer. By allowing for consumer selection, the advertisers advantageously target their information and the advertisement providers can advantageously generate revenue from the targeted advertising.

Although the advertisement 810 is disclosed with reference to its preferred embodiment where the advertisement is activated by the consumer, the invention is not intended to be limited thereby. Rather, an artisan will recognize from the disclosure herein a wide number of alternatives for the advertisement 810. For example, the feature rich advertisement 810 may advantageously show the ad space 815 and the request options 905 at the same time, thereby avoiding the need for consumer activation. Additionally, the advertisement 810 may be other than a banner advertisement.

FIG. 10 illustrates a requesting process 1000 providing consumers the ability to request information pertaining to, for example, the promotion found in the feature rich advertisement 810 of FIG. 8, according to aspects of an embodiment of the invention. As shown in FIG. 10, the requesting process 1000 begins with BLOCK 1005 when the consumer computing device 105 loads an electronic document, such as an Internet web page like page 800. The web page includes the foregoing feature rich advertisement 810, which as disclosed in the foregoing, can originate from a connected server other than the server hosting or providing the web page.

At BLOCK 1010, the consumer computing device 105 receives the activation of the advertisement 810, such as, for example, the consumer 130 mousing-over the same. According to one embodiment, when the advertisement 810 is activated, the requesting process 1000 proceeds to BLOCK 1015 and displays request options, such as, for example, those discussed with reference to FIG. 9.

According to one embodiment, various data known about the consumer 130 can be used to automatically fill in several of the request options, such as, for example, automatically filling in the text boxes corresponding to the e-mail address of the consumer 130 or an acquaintance of the same. For example, in one embodiment, the marketing system 120 receives information by way of small data files typically stored locally on the consumer computing device 105 and accessed by the browser of the same. These small data files are often referred to as cookies. The information of the cookie is compared to consumer information stored in the consumer information database 165 to attempt to identify the consumer 130. When such identification is made, data from the consumer information database 165, the cookie, or both can be used to default fill the text box with an e-mail address of the consumer 130, and default fill the one or more text boxes with the e-mail addresses of acquaintances of the consumer 130. For example, the e-mail addresses the consumer 130 used in the last submission can be used to automatically fill the foregoing text boxes. According to one embodiment, the text boxes allow the consumer 130 to replace or correct the foregoing automatically filled e-mail address data. Moreover, the marketing system 120 can advantageously update the cookie information based on any e-mail address data changed by the consumer 130.

An artisan will recognize from the disclosure herein that the e-mail address data can be automatically filled through a variety of mechanisms other than the use of cookies, or the consumer 130 may simply fill in the information at each submission.

According to one embodiment, the consumer 130 can select one or more of the request options before submitting the same by, for example, selecting multiple checkboxes in an automatic form submission. After the consumer 130 selects from the request options, the request process 1000 at BLOCK 1020 receives the selections and at BLOCK 1025 transmits this information to the marketing system 120. As discussed in the foregoing, the marketing system 120 can take a variety of actions depending upon the selections of the consumer. For example, when one of the first, second, or both preferred requests were selected, the marketing system 120 can format e-mail to send to the designated e-mail addresses. Also, when the third preferred request was selected, the marketing system 120 can redirect one or more windows in the browser of the consumer computing device 105 to details of the offer found in the ad space 815 of the feature rich advertisement 810. Such redirection can be to online information provided by, for example, the vendor of the products found in the promotion, the marketing system 120, online stores, auctions, or the like.

When the fourth preferred request was selected, the marketing system 120 can redirect one or more windows in the browser of the consumer computing device 105 to, for example, the online request based consumer information of the marketing system 120 disclosed with reference to FIG. 1-7.

Based on the foregoing, the request process 1000 provides the consumer 130 the ability to straightforwardly and efficiently request various information about the promotion found in the feature rich advertisement 810. The advertisement 810 is identified through the identifying indicia 820, and the request options are easily activated through the mouse over activation. The selections are made through straightforward checkbox selections and submitted through the submission button, thus making the requesting process 1000 highly efficient and straightforward for the 920 consumer 130.

Although the request process 1000 is disclosed with reference to preferred and alternative embodiments, an artisan will recognize from the disclosure herein alternatives to the same. For example, selection of the preferred request options can access locally stored information to generate the appropriate e-mail and/or promotional information, thereby advantageously avoiding the need to communicate with the marketing system 120. Additionally, a skilled artisan will recognize that the request options can include subscription requests to some or all of the request services disclosed with reference to FIG. 5B, or can include time and manner of delivery such as regular mail, facsimile, or the like.

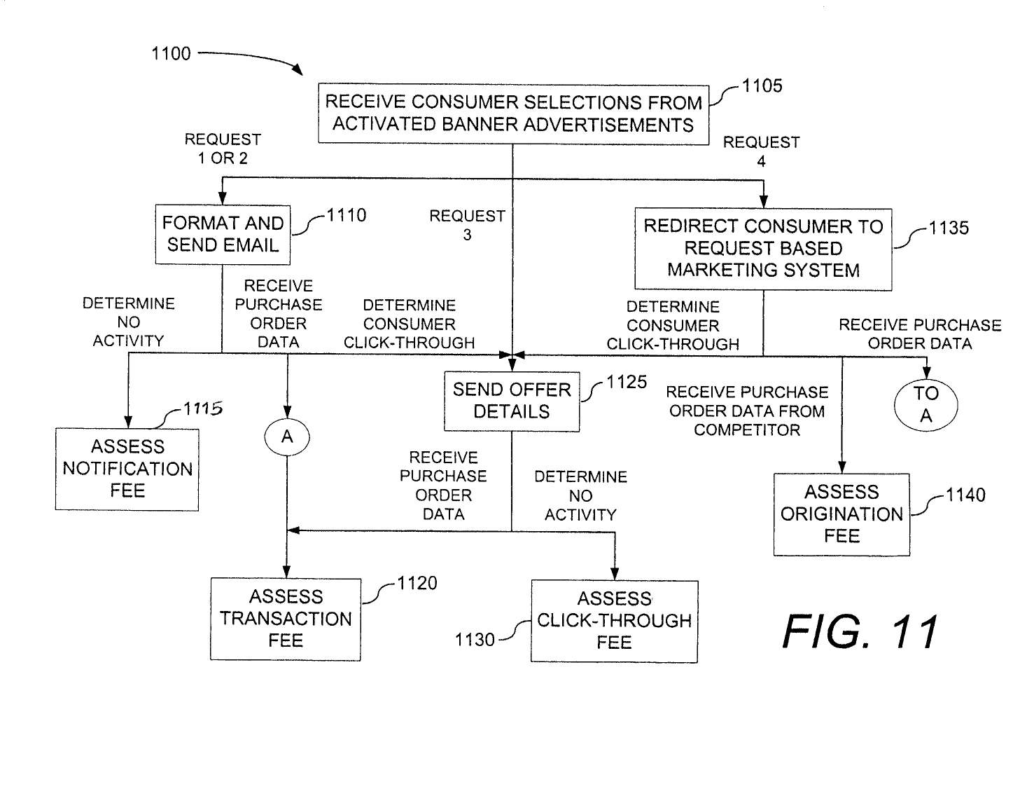

FIG. 11 illustrates a revenue process 1100 illustrating revenue generation available to, for example, the provider of the advertisement 810, according to aspects of an embodiment of the invention. As shown in FIG. 11, the revenue process 1100 defines one or more actions, which when taken, can be tied to the assessment of fees by, for example, the marketing system 120, to the vendors or retailers supplying the promotions found in the advertisements 810. Not shown in FIG. 11 but within the scope of the current disclosure, is the assessment of a placement fee, which, as a skilled artisan will recognize as similar to conventional banner advertisements, can occur when the consumer computing device 105 loads a web page which includes the advertisement 810. Such fees are generally referred to as branding fees or the like.

FIG. 11 shows that the revenue process 1100 can include other actions that generate the assessment of fees. The revenue process 1100 begins at step 1105 where the marketing system 120 receives consumer selections from, for example, an activated advertisement 810. When the consumer selections include the first or second request options, the revenue process 1100 proceeds to BLOCK 1110, where the marketing system 120 formats and sends the appropriate e-mail promotions. When the marketing system 120 determines that the recipient of the same takes no action with the e-mailings, the marketing system 120 can, at BLOCK 1115 assess a notification fee for the formatting and sending of the e-mail. According to one embodiment, the notification fee can be higher than the placement fee because the notification fee represents a targeted advertisement to consumers who have specific interest in the products or services of the promotion, and who individually or through a specific referral, received the same. As disclosed in the foregoing, such targeted request based advertising is much more effective than conventional banner advertisement campaigns.

According to one embodiment, the marketing system 120 may assess fees associated with no action on the part of the consumer 130 at the time the marketing system 130 provides the consumer 130 with information, redirects the browser of the consumer computing device 105, or the like. For example, the marketing system 120 may advantageously assess the notification fee 1115 when the notification is sent at BLOCK 1110. According to one embodiment, the marketing system 120 may assess the foregoing fee regardless of other actions taken. For example, the notification fee 1115 can be advantageously assessed when the notification is sent at BLOCK 1110, regardless of any actions of the consumer 130 and regardless of whether other fees have or will be assessed, such as, for example, transaction fees, click-through fees, response fees, origination fees, or the like.

According to one embodiment, the marketing system 120 tracks the actions of the consumer 130 through cookies, or small packages of data, accessible by the browser of the consumer computing device 105, some or all of which can be sent to the marketing system 120. Additionally, when the consumer 130 is accessing web pages of the marketing system 120, the marketing system 120 may track the requests for the same. Accordingly, when the marketing system 120 receives purchase order data derived from a purchase of one or more of the foregoing e-mailings, the marketing system 120 can, at BLOCK 1120 assess a transaction fee associated with the purchases. The transaction fee advantageously associates the actual purchase of products or services with advertising campaigns leading to those purchases. The transaction fee can advantageously be a high fee because it represents targeted advertising which actually lead the consumer 130 to a purchase activity.

Alternatively, when the marketing system 120 determines that the consumer 130 or his or her acquaintances activated the e-mail by, for example, clicking or selecting to load additional promotional information into their browsers, the marketing system 120 can, at BLOCK 1125, send the promotional information to the same. Note that such promotional information is also sent when the received consumer selections include the third request option.

Once the foregoing promotional information is loaded in the appropriate browsers, the marketing system 120 may receive purchase order data derived from one or more of the foregoing promotions loaded into the browsers. In such case, the revenue process 1100 returns to BLOCK 1120 where the marketing system 120 can assess the transaction fee associated with the purchases. On the other hand, once the promotional information is loaded into the respective browsers, the marketing system may determine that the consumer 130 or his or her acquaintances, take no further actions. In such case, the revenue process 1100 can, at BLOCK 1130, assess a click-through fee associated with the transmission of the additional promotional information. The click-through fee can advantageously be a higher fee than the placement or notification fee because it represents targeted advertising which the consumer actually reads and evaluates.

When, at BLOCK 1105, the marketing system 120 receives the consumer selection including the fourth preferred request option, the revenue process 1100 can, at BLOCK 1135, redirect the browser of the consumer computing device to some or all of the online information associated with the marketing system 120 and disclosed with reference to FIGS. 1-7. By tracking the actions of the consumer 130, the marketing system 120 may determine that the consumer requests additional promotional information. In such case, the revenue process 1100 proceeds to BLOCK 1125 and, as disclosed in the foregoing, transmits the appropriate data to the consumer 130. According to one embodiment, the consumer 130 can browse through many promotional offerings, product descriptions or the like. In addition, the supplier may offer, as disclosed with reference to FIG. 5B, surveys, product comparisons, or product reviews to the browsing consumer. When such feedback is then provided, the marketing system 120 can assess a response fee for promoting such consumer feedback. When the marketing system 120 receives purchase order data for items offered by the supplier of the original promotional information of the advertisement 810, the revenue process 1100 proceeds to BLOCK 1120 and, as disclosed in the foregoing, assesses the transaction fee.

On the other hand, when the consumer 130 browses through the information from different suppliers than that of the promotional subject matter of the original advertisement 810, and then makes a purchase from one or more of the different suppliers, the marketing system 120 receives the purchase order data from the other supplier, and at BLOCK 1140, can assess an origination fee. According to one embodiment, the origination fee corresponds to a down-click-stream fee based on the fact that one advertiser paid to direct a consumer to purchase another supplier's products or services. For example, the consumer 130 can view ABC Inc.'s feature rich advertisement 810 and then click through to the marketing system 120 where they are able to link to XYZ's website. Once at XYZ's site, they complete a purchase. Because the consumer 130 originated from ABC Inc.'s advertisement and a purchase was completed at XYZ's site, then ABC Inc. and the marketing system 120 can participate in a revenue share with XYZ. Such down-click-stream revenue sharing from a single sale, advantageously and appropriately rewards the supplier who paid for the original advertisement which caught the attention of the consumer 130.

According to one embodiment, ABC and XYZ can even compete in one or more product lines. Thus, the foregoing affiliate-like revenue sharing extends beyond any conventional affiliate program in that, among other things, actual competitors can end up sharing revenue from, for example, comparison shopping purchasers originating from one or the other's promotional advertising.

Although the foregoing revenue process 1100 has been described in terms of certain embodiments, other embodiments will be apparent to those of ordinary skill in the art from the disclosure herein. For example, as disclosed with reference to FIG. 9, one, multiple, or all of the request options 905 can be selected, and therefore, one, multiple, or every option can be traversed with respect to FIG. 11 for a single submission from the advertisement 810 by the consumer. As will be recognized from the disclosure herein, such multiple actions will generate the assessment of potentially many overlapping fees, and, according to one embodiment, the marketing system 120 can advantageously determine whether one, some, or all the fees will actually be assessed. For example, the promotion supplier may have agreed to pay one, some, or all of the foregoing overlapping fees.

Although the foregoing invention has been described in terms of certain preferred embodiments, other embodiments will be apparent to those of ordinary skill in the art from the disclosure herein. For example, the computer networks can include private networks, in-store kiosk networks, or the like. Moreover, the feature rich advertisement 810 may include the ad space 815 and the request options 905 in a single window, thereby avoiding the consumer activation of the same. Alternatively, consumer activation of the feature rich advertisement 810 can present a window including the ad space 815 and the request options 905, thereby advantageously leaving the ad space 815 viewable to the consumer 130.

Additionally, other combinations, admissions, substitutions, and modifications will be apparent to an artisan in view of the disclosure herein. Accordingly, the present invention is not intended to be limited by the reaction of the preferred embodiment that is defined by reference to the appended claims.

All publications, patents, and patent applications mentioned in this specification are herein incorporated by reference to the same extent as if each individual publication, patent, or patent application was specifically and individually indicated to be incorporated by reference.

What is claimed is:

1. A feature rich advertisement to be displayed on a consumer computing device, the feature rich advertisement comprising:
ad space including one or more promotions to be displayed on a consumer computing device; and
at least one request option selectable by a consumer, the request option providing that information associated with the one or more promotions will be delivered via e-mail to an e-mail address entered or confirmed by the consumer.

2. The feature rich advertisement of claim 1, wherein the e-mail address entered comprises one or more e-mail addresses of one or more acquaintances of the consumer.

3. The feature rich advertisement of claim 1, further comprising an additional request option selectable by the consumer, wherein the additional request option provides that at least one window of a browser of the consumer computing device will be redirected to a supplier of the one or more promotions to receive additional information corresponding to the one or more promotions.

4. The feature rich advertisement of claim 1, further comprising an additional request option selectable by the consumer, wherein the additional request option provides that at least one window of a browser of the consumer computing device will be redirected to a provider of the one or more promotions to receive additional information corresponding to at least a supplier of the one or more promotions.

5. The feature rich advertisement of claim 4, wherein the additional information comprises at least one of discounts, new releases, catalogs, and special offers.

6. The feature rich advertisement of claim 1, wherein the at least one request option appears when the consumer activates the advertisement.

7. The feature rich advertisement of claim 6, wherein the activation of the advertisement comprises the consumer mousing-over the ad space.

8. The feature rich advertisement of claim 6, wherein the ad space is at least partially covered by the at least one request option after activation of the advertisement.

9. The feature rich advertisement of claim 6, wherein the ad space and the at least one request option is viewable after activation of the advertisement.

10. The feature rich advertisement of claim 1, further comprising identifying indicia identifying the advertisement as a feature rich advertisement.

11. The feature rich advertisement of claim 10, wherein the identifying indicia comprises an animated object.

12. The feature rich advertisement of claim 10, wherein the identifying indicia comprises a cube-like object.

13. The feature rich advertisement of claim 1, further comprising at least one selection mechanism for selecting the at least one request option.

14. The feature rich advertisement of claim 1, wherein the advertisement comprises a banner advertisement.

15. A method of providing feature rich advertisements having consumer selectable requests allowing a consumer to request that information corresponding to a supplier's promotion be delivered to an e-mail address designated by the consumer, the method comprising:
providing a feature rich advertisement including promotional information to a web page loaded into a browser of a consumer computing device;
receiving a consumer selected request for information related to the promotional information, the consumer selected request designating at least one e-mail address; and
sending the information to the at least one e-mail address via e-mail.

16. The method of claim 15, wherein the at least one e-mail address comprises at least one e-mail address of an acquaintance of the consumer.

17. The method of claim 15, further comprising receiving a consumer selected request to redirect the browser to a supplier of the promotional information.

18. The method of claim 15, further comprising:
receiving a consumer selected request to redirect the browser to a provider of the promotional information; and
sending the browser additional information comprising at least one of discounts, new releases, catalogs, and special offers.

19. The method of claim 18, wherein the additional information corresponds to products or services of a supplier of the promotional information.

20. The method of claim 18, wherein the additional information corresponds to products or services of one or more suppliers other than a supplier the promotional information.

21. A method of generating revenue from actions associated with a feature rich advertisement displayed on a consumer computing device, the method comprising:
assessing a transaction fee when a consumer purchases a product from a promotion in an e-mail requested by one of the consumer or an acquaintance of the consumer from a feature rich advertisement displayed on a consumer computing device;
assessing a notification fee when the consumer receives the e-mail; and
assessing a click-through fee when the consumer uses the e-mail to request additional information about the promotion.

22. The method of claim 21, further comprising assessing a placement fee when a web page is loaded including the feature rich advertisement.

23. The method of claim 21, further comprising assessing an origination fee when the consumer makes a purchase from a different supplier than a supplier of the promotion after being directed to the different supplier's web page by information found on a web page related to the promotion.
